(19) United States
(12) Patent Application Publication
(10) Pub. No.: US 2025/0212259 A1
(43) Pub. Date: Jun. 26, 2025

(54) TECHNIQUES FOR SECRET KEY EXTRACTION DURING AN ACCESS PROCEDURE

(71) Applicant: QUALCOMM INCORPORATED, San Diego, CA (US)

(72) Inventors: Ahmed Elshafie, San Diego, CA (US); Alexandros Manolakos, Athens (GR); Hung Dinh Ly, San Diego, CA (US)

(21) Appl. No.: 18/848,825

(22) PCT Filed: Mar. 23, 2023
(86) PCT No.: PCT/US2023/016077

§ 371 Date: Sep. 19, 2024

(30) Foreign Application Priority Data
May 9, 2022 (GR) 20220100385

(51) Int. Cl. H04W 74/0833; H04B 7/06; H04L 5/00; H04W 12/041

(52) U.S. Cl. CPC H04W 74/0833; H04B 7/06968; H04L 5/0051; H04W 12/041

(57) ABSTRACT

Methods, systems, and devices for wireless communications are described. A user equipment (UE) may receive control information indicating that a network entity supports key derivation associated with a random access procedure. Based on the control information, the UE and the network entity may measure one or more reference signals transmitted by the network entity during or prior to the random access procedure to generate a channel estimate of a wireless communication channel between the UE and the network entity. The UE and the network entity may communicate, during the random access procedure, an indication of a match or a mismatch between a first verification bit sequence generated by the UE using a first key derived from the channel estimate and a second verification bit sequence generated by the network entity using a second key derived by the network entity.

### CROSS REFERENCE

The present application is a 371 national stage filing of International PCT Application No. PCT/US2023/016077 by ELSHAFIE et al. entitled “TECHNIQUES FOR SECRET KEY EXTRACTION DURING AN ACCESS PROCEDURE,” filed Mar. 23, 2023; and claims priority to Greece Patent Application No. 20220100385 by ELSHAFIE et al. entitled “TECHNIQUES FOR SECRET KEY EXTRACTION DURING AN ACCESS PROCEDURE,” filed May 9, 2022, each of which is assigned to the assignee hereof, and each of which is expressly incorporated by reference in its entirety herein.

### FIELD OF TECHNOLOGY

The following relates to wireless communications, including techniques for secret key extraction during an access procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support communications between a user equipment (UE) and a network entity (e.g., a base station) using a random access procedure. For example, the UE and network entity may perform a 4-step random access channel (RACH) procedure or a 2-step RACH procedure. In some examples, however, one or more communications (e.g., physical layer communications) in the RACH procedure may be relatively insecure.

### SUMMARY

The described techniques relate to improved methods, systems, devices, and apparatuses that support techniques for secret key extraction during an access procedure. The techniques described herein provide for performing a secret key (SK) extraction during an access procedure (e.g., random access channel (RACH) procedure). For example, a UE and a network entity may communicate reference signals prior to or during an access procedure. Each device may be configured to measure the received reference signals to determine a channel estimate and an SK. The channel experienced at each device may be the same or similar enough for each of the devices to measure the same or similar channel metrics, and thus derive a same key from the channel metrics.

The devices may verify their respective keys during the access procedure. For example, one of the UE or network entity may be configured to send a verification bit sequence, based on the respective SK, to the other device. The receiving device may compare the received bit sequence to its own generated bit sequence, and determine a match or a mismatch between the two bit sequences. The receiving device may indicate an acknowledgement (ACK) or a negative acknowledgement (NACK) to the other device based on whether the bit sequences match. When a match is determined and indicated, the UE and the network entity device may securely communicate via the communication channel by encrypting (e.g., cyphering, encoding) subsequent communications with the SK. The UE and the network entity may leverage the SK to prevent eavesdropping devices from accessing initial access communications or determining the SK. For example, because the SK is determined and verified during the initial access communications, a portion of the access procedure may be secured, a key for securing communications sooner may be obtained (e.g., communications subsequent to the access procedure may be secured sooner due to obtaining the key during the access procedure), or both, among other benefits.

A method for wireless communications at a user equipment (UE) is described. The method may include receiving control information indicating that a network entity supports key derivation associated with a random access procedure with the network entity, measuring, based on the control information, one or more reference signals transmitted by the network entity during or prior to the random access procedure to generate a channel estimate of a wireless communication channel between the UE and the network entity, and communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

An apparatus for wireless communications at a UE is described. The apparatus may include a processor, memory coupled with the processor, and instructions stored in the memory. The instructions may be executable by the processor to cause the apparatus to receive control information indicating that a network entity supports key derivation associated with a random access procedure with the network entity, measure, based on the control information, one or more reference signals transmitted by the network entity during or prior to the random access procedure to generate a channel estimate of a wireless communication channel between the UE and the network entity, and communicate, with the network entity during the random access procedure, an indication of one of a match or a mismatch between a first verification bit sequence generated by the UE using a first key derived from the channel estimate and a second verification bit sequence generated by the network entity using a second key derived by the network entity.

Another apparatus for wireless communications at a UE is described. The apparatus may include means for receiving control information indicating that a network entity supports key derivation associated with a random access procedure with the network entity, means for measuring, based on the control information, one or more reference signals transmitted by the network entity during or prior to the random access procedure to generate a channel estimate of a wireless communication channel between the UE and the network entity, and means for communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

A non-transitory computer-readable medium storing code for wireless communications at a UE is described. The code may include instructions executable by a processor to receive control information indicating that a network entity supports key derivation associated with a random access procedure with the network entity, measure, based on the control information, one or more reference signals transmitted by the network entity during or prior to the random access procedure to generate a channel estimate of a wireless communication channel between the UE and the network entity, and communicate, with the network entity during the random access procedure, an indication of one of a match or a mismatch between a first verification bit sequence generated by the UE using a first key derived from the channel estimate and a second verification bit sequence generated by the network entity using a second key derived by the network entity.

Some examples of the method, apparatuses, and non-transitory computer-readable medium described herein may further include operations, features, means, or instructions for receiving the one or more reference signals in a resource allocated for transmission of a random access response message of the random access procedure.

Some examples of the method, apparatuses, and non-transitory computer-readable medium described herein may further include operations, features, means, or instructions for communicating one or more messages secured using the first key derived from the channel estimate based on communicating the indication of a match between the first verification bit sequence and the second verification bit sequence, the one or more messages communicated during the random access procedure, after the random access procedure, or both.

Some examples of the method, apparatuses, and non-transitory computer-readable medium described herein may further include operations, features, means, or instructions for communicating a message of the random access procedure that may have a quasi co-location relationship with the one or more reference signals.

In some examples of the method, apparatuses, and non-transitory computer-readable medium described herein, receiving the control information may include operations, features, means, or instructions for receiving the control information via a master information block, a system information block, a message of the random access procedure, or any combination thereof.

Some examples of the method, apparatuses, and non-transitory computer-readable medium described herein may further include operations, features, means, or instructions for receiving second control information indicating a metric associated with measuring the channel estimate and obtaining the first key using the metric associated with the channel estimate.

Some examples of the method, apparatuses, and non-transitory computer-readable medium described herein may further include operations, features, means, or instructions for communicating a signal indicating the first verification bit sequence or the second verification bit sequence, where communicating the indication of the match or the mismatch may be based on communicating the signal.

Some examples of the method, apparatuses, and non-transitory computer-readable medium described herein may further include operations, features, means, or instructions for receiving second control information indicating a resource for communicating the indication of one of the match or the mismatch.

Some examples of the method, apparatuses, and non-transitory computer-readable medium described herein may further include operations, features, means, or instructions for receiving a message of the random access procedure, the message including control information indicating the second verification bit sequence.

Some examples of the method, apparatuses, and non-transitory computer-readable medium described herein may further include operations, features, means, or instructions for communicating the indication of the mismatch between the first verification bit sequence and the second verification bit sequence and receiving a message of the random access procedure indicating whether one or more subsequent messages communicated between the UE and the network entity may be unsecured based on the mismatch.

Some examples of the method, apparatuses, and non-transitory computer-readable medium described herein may further include operations, features, means, or instructions for communicating one or more messages subsequent to the random access procedure that may be encrypted using the first key, the one or more messages indicating to update the first key to a third key.

Some examples of the method, apparatuses, and non-transitory computer-readable medium described herein may further include operations, features, means, or instructions for obtaining the first key using the channel estimate of the wireless communication channel, where communicating the indication of one of the match or the mismatch may be based on obtaining the first key.

Some examples of the method, apparatuses, and non-transitory computer-readable medium described herein may further include operations, features, means, or instructions for receiving the one or more reference signals prior to the random access procedure, where measuring the one or more reference signals may be based on receiving the one or more reference signals.

Some examples of the method, apparatuses, and non-transitory computer-readable medium described herein may further include operations, features, means, or instructions for generating the channel estimate based on measuring the one or more reference signals, the channel estimate including a demodulation reference signal metric, a log likelihood ratio metric, or a combination thereof.

A method for wireless communications at a network entity is described. The method may include transmitting control information indicating that the network entity supports key derivation associated with a random access procedure with the network entity, measuring, based on the control information, one or more reference signals transmitted by a UE during the random access procedure to generate a channel estimate of a wireless communication channel between the UE and the network entity, and communicating, during the random access procedure, an indication of one of a match or a mismatch between a first verification bit sequence generated by the UE using a first key derived by the UE and a second verification bit sequence using a second key derived from the channel estimate by the network entity.

An apparatus for wireless communications at a network entity is described. The apparatus may include a processor, memory coupled with the processor, and instructions stored in the memory. The instructions may be executable by the processor to cause the apparatus to transmit control information indicating that the network entity supports key derivation associated with a random access procedure with the network entity, measure, based on the control information, one or more reference signals transmitted by a UE during the random access procedure to generate a channel estimate of a wireless communication channel between the UE and the network entity, and communicate, during the random access procedure, an indication of one of a match or a mismatch between a first verification bit sequence generated by the UE using a first key derived by the UE and a second verification bit sequence using a second key derived from the channel estimate by the network entity.

Another apparatus for wireless communications at a network entity is described. The apparatus may include means for transmitting control information indicating that the network entity supports key derivation associated with a random access procedure with the network entity, means for measuring, based on the control information, one or more reference signals transmitted by a UE during the random access procedure to generate a channel estimate of a wireless communication channel between the UE and the network entity, and means for communicating, during the random access procedure, an indication of one of a match or a mismatch between a first verification bit sequence generated by the UE using a first key derived by the UE and a second verification bit sequence using a second key derived from the channel estimate by the network entity.

A non-transitory computer-readable medium storing code for wireless communications at a network entity is described. The code may include instructions executable by a processor to transmit control information indicating that the network entity supports key derivation associated with a random access procedure with the network entity, measure, based on the control information, one or more reference signals transmitted by a UE during the random access procedure to generate a channel estimate of a wireless communication channel between the UE and the network entity, and communicate, during the random access procedure, an indication of one of a match or a mismatch between a first verification bit sequence generated by the UE using a first key derived by the UE and a second verification bit sequence using a second key derived from the channel estimate by the network entity.

Some examples of the method, apparatuses, and non-transitory computer-readable medium described herein may further include operations, features, means, or instructions for transmitting the one or more reference signals in a resource allocated for transmission of a random access response message of the random access procedure.

Some examples of the method, apparatuses, and non-transitory computer-readable medium described herein may further include operations, features, means, or instructions for communicating one or more messages secured using the second key derived from the channel estimate based on communicating the indication of a match between the first verification bit sequence and the second verification bit sequence, the one or more messages communicated during the random access procedure, after the random access procedure, or both.

Some examples of the method, apparatuses, and non-transitory computer-readable medium described herein may further include operations, features, means, or instructions for communicating a message of the random access procedure that may have a quasi co-location relationship with the one or more reference signals.

In some examples of the method, apparatuses, and non-transitory computer-readable medium described herein, transmitting the control information may include operations, features, means, or instructions for transmitting the control information via a master information block, a system information block, a message of the random access procedure, or any combination thereof.

Some examples of the method, apparatuses, and non-transitory computer-readable medium described herein may further include operations, features, means, or instructions for transmitting second control information indicating a metric associated with the measuring channel estimate and obtaining the second key using the metric associated with the channel estimate.

Some examples of the method, apparatuses, and non-transitory computer-readable medium described herein may further include operations, features, means, or instructions for communicating a signal indicating the first verification bit sequence or the second verification bit sequence, where communicating the indication of the match or the mismatch may be based on communicating the signal.

Some examples of the method, apparatuses, and non-transitory computer-readable medium described herein may further include operations, features, means, or instructions for transmitting second control information indicating a resource for communicating the indication of one of the match or the mismatch.

Some examples of the method, apparatuses, and non-transitory computer-readable medium described herein may further include operations, features, means, or instructions for transmitting a message of the random access procedure, the message including control information indicating the second verification bit sequence.

Some examples of the method, apparatuses, and non-transitory computer-readable medium described herein may further include operations, features, means, or instructions for communicating the indication of the mismatch between the first verification bit sequence and the second verification bit sequence and transmitting a message of the random access procedure indicating whether one or more subsequent messages communicated between the UE and the network entity may be unsecured based on the mismatch.

Some examples of the method, apparatuses, and non-transitory computer-readable medium described herein may further include operations, features, means, or instructions for communicating one or more messages subsequent to the random access procedure that may be encrypted using the first key, the one or more messages indicating to update the first key to a third key.

Some examples of the method, apparatuses, and non-transitory computer-readable medium described herein may further include operations, features, means, or instructions for obtaining the second key using the channel estimate of the wireless communication channel, where communicating the indication of one of the match or the mismatch may be based on obtaining the second key.

Some examples of the method, apparatuses, and non-transitory computer-readable medium described herein may further include operations, features, means, or instructions for transmitting the one or more reference signals prior to the random access procedure, where measuring the one or more reference signals may be based on transmitting the one or more reference signals.

Some examples of the method, apparatuses, and non-transitory computer-readable medium described herein may further include operations, features, means, or instructions for generating the channel estimate based on measuring the one or more reference signals, the channel estimate including a demodulation reference signal metric, a log likelihood ratio metric, or a combination thereof

### BRIEF DESCRIPTION OF THE DRAWINGS

FIG. 1 illustrates an example of a wireless communications system that supports techniques for secret key extraction during an access procedure in accordance with one or more aspects of the present disclosure.

FIG. 2 illustrates an example of a wireless communications system that supports techniques for secret key extraction during an access procedure in accordance with one or more aspects of the present disclosure.

FIGS. 3, 4, and 5 illustrate examples of process flows that support techniques for secret key extraction during an access procedure in accordance with one or more aspects of the present disclosure.

FIGS. 6 and 7 show block diagrams of devices that support techniques for secret key extraction during an access procedure in accordance with one or more aspects of the present disclosure.

FIG. 8 shows a block diagram of a communications manager that supports techniques for secret key extraction during an access procedure in accordance with one or more aspects of the present disclosure.

FIG. 9 shows a diagram of a system including a device that supports techniques for secret key extraction during an access procedure in accordance with one or more aspects of the present disclosure.

FIGS. 10 and 11 show block diagrams of devices that support techniques for secret key extraction during an access procedure in accordance with one or more aspects of the present disclosure.

FIG. 12 shows a block diagram of a communications manager that supports techniques for secret key extraction during an access procedure in accordance with one or more aspects of the present disclosure.

FIG. 13 shows a diagram of a system including a device that supports techniques for secret key extraction during an access procedure in accordance with one or more aspects of the present disclosure.

FIGS. 14 through 16 show flowcharts illustrating methods that support techniques for secret key extraction during an access procedure in accordance with one or more aspects of the present disclosure.

### DETAILED DESCRIPTION

A wireless communications system may include wireless communications devices, such as a user equipment (UE) and a network entity, that support access procedures (e.g., random access procedures). For example, a UE may establish a connection with a network using a random access procedure, such as a 4-step random access channel (RACH) procedure or a 2-step RACH procedure. In some cases, the random wireless communications devices may use one or more security measures to secure communications external devices. For example, a wireless communications system may perform secret key (SK) sharing for a pair of wireless communications devices to extract an SK from the channel. The devices may secure one or more unsecured channels (e.g., physical uplink control channels (PUCCH) or downlink control information (DCI)), further improve the security of other channels (e.g., physical downlink shared channel (PDSCH) or physical uplink shared channel (PUSCH)), or both. In some examples of SK extraction methods, (e.g., a type-A SK extraction method) two devices transmit reference signals to each other, and respectively estimate a channel based on the received reference signals. Each device may obtain one or more metrics based on the channel, and each device may derive an SK from the one or more metrics. However, the communications in the RACH procedure may be relatively insecure. For example, in conventional systems, physical layer communications or other communications during a random access procedure may not use an SK or other security methods. Alternatively, the communications may be secured after initial access (e.g., in a connected mode), which may leave communications during initial access susceptible to external devices or other security concerns.

The techniques described herein may enable a wireless communications system to perform one or more SK extraction methods during an initial access procedure. For example, a UE and a network entity may perform the SK extraction procedure to agree on an SK for securing subsequent transmissions and to prevent security breaches from external devices. In some cases, the network entity may transmit control information indicating that the network entity will apply the SK extraction procedure. The UE may receive the control information (e.g., through a master information block (MIB), a system information block (SIB), a message of the random access (e.g., msg2), or a combination thereof), and be configured with one or more resources for performing the SK extraction procedure.

The UE and the network entity may each receive one or more reference signals during or prior to the random access procedure from the other device. For example, the UE may receive one or more reference signals (e.g., synchronization signal blocks (SSBs)) from the network entity and the network entity may receive one or more reference signals (e.g., reference signals in PRACH messages or other examples of reference signals) from the UE. Each device may measure the received reference signals and generate a respective channel estimate of the wireless communication channel between the UE and the network entity. For example, each channel estimates may include one or more demodulation reference signal (DMRS) metrics, one or more of a log likelihood ratio (LLR) metrics, or both. Based on their channel estimates and the associated SK metrics, the UE and the network entity may each obtain a respective SK.

The UE and the network entity may perform an SK verification process to verify the SK agreement. For example, the two SKs may be compared to determine either a match or a mismatch. In order to perform the SK verification, the UE and the network entity may each generate a verification bit sequence associated with their SK. One of the UE and the network entity may transmit the respective verification bit sequence to the other device. For example, the UE may transmit a first verification bit sequence to the network entity, or the network entity may transmit a second verification bit sequence to the UE. The receiving device (e.g., either the UE or the network entity) may compare the first verification bit to the second verification bit in order to determine a match or a mismatch of the bits. If a match is determined, the derived SKs allow for an SK agreement between the UE and the network entity. If a mismatch is determined, an SK agreement has not been established and the subsequent communications may not be secured.

The determining device may indicate the match or mismatch to the other device. For example, the UE or the network entity may perform an acknowledgement (ACK) (e.g., for a match) or non-acknowledgement (NACK) (e.g., for a mismatch) in response to the received verification bit sequence, indicating either a match or a mismatch. The ACK or NACK response from the respective device may indicate whether the communications system may secure one or more remaining messages using the SK. For example, when a NACK response is transmitted and received, and the SK agreement is not viable, the SK may not be used to secure the subsequent communications. In some cases, when an SK agreement is not viable, the subsequent communication may be performed without an SK security method. Alternatively, when an ACK response is transmitted and received, and the SK agreement is viable, the SK may be used to secure the remaining messages. In some cases, when SK agreement is viable, the UE and the network entity may communicate one or more messages secured (e.g., encrypted) using the SK. In some examples, the secured messages may be communicated during the random access procedure, after the random access procedure, or both. In some examples, one or more messages of the messages, (e.g., after the random access procedure) may indicate an update to the SK. For example, one of the UE network entity may receive one or more messages that are secured using the agreed upon SK, indicating to update the agreed upon SK to a new SK.

Aspects of the disclosure are initially described in the context of wireless communications systems. Examples of processes and signaling exchanges that support secret key extraction during an access procedure are then described. Aspects of the disclosure are further illustrated by and described with reference to apparatus diagrams, system diagrams, and flowcharts that relate to techniques for secret key extraction during an access procedure.

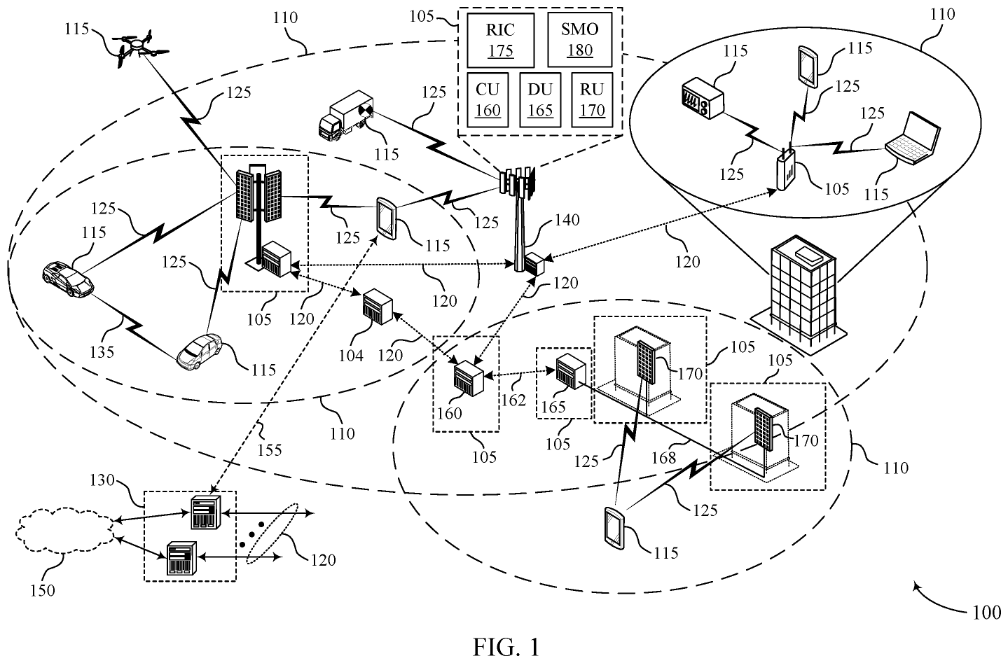

FIG. 1 illustrates an example of a wireless communications system 100 that supports techniques for secret key extraction during an access procedure in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for secret key extraction during an access procedure as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In the wireless communications system 100, a UE 115 and a network entity 105 (e.g., an eNodeB (eNB), a next-generation NodeB or a giga-NodeB, either of which may be referred to as a gNB, or some other base station), may support wireless communications during a random access procedure. The UE 115 and the base station 105 may perform an SK extraction during an access procedure. For example, each device may transmit reference signals to the other device prior to or during a RACH procedure. Each device may be configured to measure the received reference signals to determine a channel estimate and an SK. The channel between the devices may be the same or similar enough channel for each of the devices to measure the same or similar channel metrics, and thus derive the same key from the channel metrics.

The devices may verify their respective keys during the RACH procedure. For example, one of the UE or network entity may be configured to send a verification bit sequence, based on the respective SK, to the other device. The receiving device may compare the received bit sequence to its own bit sequence, and determine a match or a mismatch between the two bit sequences. The comparing device may indicate an ACK or a NACK to the other device based on whether the bit sequences match. When a match is determined and indicated, the devices may secure subsequent communications using the SK.

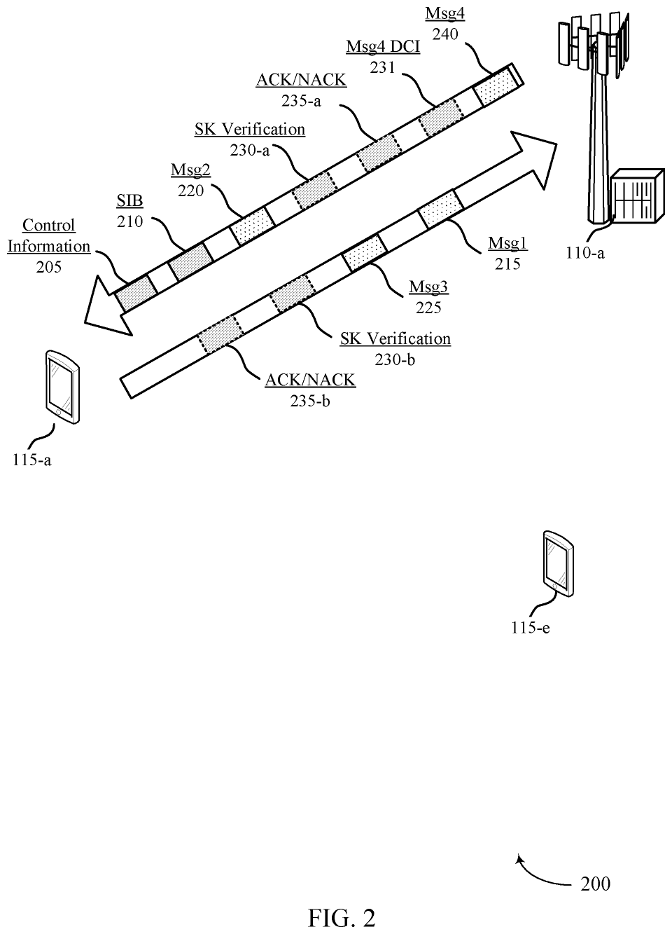

FIG. 2 illustrates an example of a communications system 200 that supports techniques for secret key extraction during an access procedure in accordance with one or more aspects of the present disclosure. For example, the wireless communications systems 200 may include a base station 105-a and a UE 115-a, which may be examples of a base station 105 and a UE 115 as described herein.

During an initial access process, a UE 115-a and a network entity 105-a may perform an SK extraction procedure over uplink and downlink communication links. For example, the UE 115-a and the network entity 105-a may use the SK extraction procedure to agree on an SK for securing subsequent transmissions (e.g., the msg4 240, another system information block (OSIB), and any messages occurring before a connected mode) from other devices (e.g., UE 115-c). In some cases, the network entity 105-a may indicate if it will apply the SK extraction procedure through control information 205. The UE 115-a may receive, from the network entity 105-a, the control information 205 indicating that the network entity 105-a supports SK derivation associated with a random access procedure with the network entity 105-a. In some examples, the UE may receive the control information 205 through a MIB, SIB 210, a message of the random access procedure 215, 220, 223, or 240, or a combination thereof. For example, the network entity 105-a may transmit an MIB indicating that the SK-extraction procedure may use one or more transmissions SSBs, msg2 220, and msg4 240, msg 3 225 and msg1 215, or some combination thereof). Alternatively, the network entity 105-a may use an SIB 210, msg2 220, or OSIB to indicate if it will apply the procedure. In some other examples, the network entity 105-a may use a SIB 210, msg2, 220 or OSIB transmissions to indicate SK extraction metrics to evaluate the SK. In some cases, the SK-extraction procedure information may be indicated in a specification set by a standards body, implicitly signaled, explicitly signaled. In some cases, multiple SK procedures may be permitted, and the network entity may indicate via signaling which SK procedure is being used by the network entity, a configuration for a SK procedure being used by the network entity, or both.

The UE 115-a may receive one or more reference signals during or prior to the random access procedure. For example, the UE may receive one or more reference signals in a resource allocated for the transmission of a random access response message (e.g., msg2 220, msgB) during the random access procedure. Additionally or alternatively, the UE may receive one or more reference signals as SSBs over an SSB beam before performing the random access procedure (e.g., 205). In order to maintain the same channel conditions and reciprocity, the same transmission and reception beams may be used to transmit the SSB beam to the UE 115-a and to receive the SSB beam at the UE 115-a. For example, the network entity 105-a may use the beam selected by UE 115-a as a receiving beam (e.g., for msg3 225). Additionally or alternatively, UE 115-a may use the same beam selected to receive the SSB (e.g., on the selected SSB index) as a transmit beam (e.g., for msg3 225).

The antenna port and beams used by a node for downlink and uplink are the same. In some examples, multiple transmissions may have a quasi co-location (QCL) relationship with one or more reference signals. For example, one or more messages from the random access procedure (e.g., msg1 215 and msg3 225 transmitted by a UE, and msg2 220 and msg4 240 transmitted by the network entity) may be transmitted by quasi co-located antenna ports to observe the same channels for both transmissions (e.g., the ports may be quasi co-located using QCL type A or QCL type D). In some examples, the same transmit antenna port or ports used by the UE to transmit msg1 are used to transmit msg3 (e.g., the analog and digital beamformer used to transmit msg1 is used to transmit msg3). Additionally, the network entity can use the same beamformer or filter to receive signals (e.g., the analog and digital beamformer used to receive msg1 is used to receive msg3). Additionally or alternatively, the network entity may use the same antenna ports to transmit SSB, msg3, msg4 while the UE may use the same analog and digital beamformer or filter to receive those signals. In some cases, to obtain the same SK by achieving the same channel characteristics and measurements at UE and network device, the UE, network entity, or both may transmit and receive signals with the same antenna port or filter (i.e., the UE can transmit msg1 using the same analog and digital beamformer or filter that is used to receive SSB or SIB1). In an example, an SSB may be used as a common reference signal used by UEs to extract physical layer secret keys using channel-based methods. For the network device to also obtain the SK (and the exact key is obtained at both sides) during the initial access, UEs can use a random access message (e.g., msg2) from the network entity and the network entity may use another random access message (e.g., msg3 PUSCH) from the UE to obtain a channel estimate (CE) metric. With the QCL relation between msg1 (or msgA) or PUSCH's msg3 (or msgA) and either SSB, the PDSCH of msg3, or msg4, both a UE and network device may derive the same key. For example, the CE metric derived by each of the UE and the network device may be the same, similar, or highly correlated (e.g., one channel can be inferred with some acceptable error from other channel), especially at high SNR, and may result in the same or a similar SK. PUSCH and PDSCH repetitions may also be used to enhance derivation of the same SK. In some examples, physical layer security and secret-key sharing may occur where a pair of devices (gNB and a UE or pair of UEs in a SL) try to extract a secret key from the channel. The gNB and UE may use the derived secret key to secure some unsecured channels (msg2, msg3, msg4, and OSIB or PUCCH and DCI) and further improve security of other channels such as PDSCH or PUSCH from a physical layer security respective.

Based on receiving the control information 205 and the reference signals, the UE 115-a may measure the reference signals transmitted by the network entity 105-a (e.g., msg2 220). For example, the UE 115-a may measure the reference signals to generate a channel estimate of a wireless communication channel between the UE 115-a and the network entity 105-a. Additionally or alternatively, the network entity 105-a may measure one or more reference signals transmitted by the UE 115-a (e.g., msg3 225) to generate a channel estimate of the wireless communication channel. In some examples, the one or more reference signals may be one or more demodulation reference signals (DMRSs). In these examples, the channel estimates may include or be associated with one or more DMRS metrics. For example, the channel estimates may be a measurement of an DMRS amplitude (e.g., an instantaneous channel amplitude) of one or more resource elements (REs) or a measurement of a DMRS phase (e.g., an instantaneous channel phase) of one or more REs. Additionally or alternatively, the channel estimates may be a measurement of a DMRS amplitude or a measurement of a DMRS phase averaged across a set of one or more REs, one or more resource blocks (RBs), one or more physical resource blocks (PRBs), or one or more resource block groups (RGBs). Additionally or alternatively, the channel estimate may be a measurement of a signal to interference and noise ratio (SINR), a channel quality indication (CQI), a modulation and coding scheme (MCS), one or more channel statistics (e.g., doppler, delay spread, average delay), or some combination thereof. In some cases, the channel estimates may include or be associated with one or more of LLR metrics. For example, the channel estimates may be instant channel measurements or values (e.g., channel magnitude, channel phase, or combination thereof), an instant LLR on a set of one or more REs, an SINR, a CQI, an MCS, or some combination thereof.

The UE 115-a and the network entity 105-a may each determine a respective SK metric using a one or more of the channel metrics (e.g., DMRS or LLR metrics) described herein. For example, the SK metric may be a single channel estimate measurement or a combination of one or more channel estimate metrics. In some cases, the SK metrics may not be reported by the UE 115-a or the network entity 105-a. Instead, the SK metrics may be quantized into a number (e.g., L) of levels. Each SK metric level may correspond to a different SK seed from a set of available SK seeds. Additionally or alternatively, a particular SK metric observed by the UE 115-a or the network entity 105-a may correspond to a particular SK seed.

The UE 115-a and the network entity 105-a may each input their respective SK seeds into a key generator to derive a respective SK. For example, the key generator may be used to derive one or more SKs. In some examples, each of the UE 115-a and the network entity 105-a may be configured to use the same SK generator (e.g., a pseudo-random generator, a key derivation function (e.g., hash-based message authentication code (HMAC) or a keyed hash function), or the like). For example, the UE 115-a may use the SK generator to derive a first SK based on the UE 115-a's SK seed and the network entity 105-a may use the SK generator to derive a second SK based on the network entity 105-a's SK seed. Provided that the UE 115-a and the network entity 105-a observed the same or similar SK metrics, and therefore obtain the same SK seed, then both the UE 115-a and the network entity 105-a would derive the same SK. In some cases, the set of available SK seeds may be extended using secured pseudo-random generators, a key derivation function (e.g., hash-based message authentication code (HMAC) or a keyed hash function), or both, that periodically refresh the key. Additionally or alternatively, the SK seed may be changed or updated when one or more other reference signal resources are available.

In some cases, the determined SKs may be used to secure remaining transmissions, subsequent to the reference signals. For example, the UE 115-a and the network entity 105-a may use the SK to secure msg4 240, OSIB, or one or more other messages transmitted before a connected mode is established. In some examples, the DCI, UCI, or both for ongoing transmissions may also be secured using the determined SK until new reference signal resources are available and a new SK is derived.

The UE 115-a may generate a first verification bit sequence using the first SK. Additionally or alternatively, the network entity 105-a may generate a second verification bit sequence using the second SK. For example, an SK verification sequence may include transmitting a sequence-based signal 230 over one or more verification resources (e.g., time resources, frequency resources, or a combination thereof). In some examples, the verification resources may be indicated by the control information 205. Additionally or alternatively, the verification resources, the sequence-based signal 230, or both, may be selected partially or fully based on part or all of an SK. For example, the sequence-based signal 230-a may use a most significant bit (MSB), a least significant bit (LSB), or a fixed-size value (e.g., a hash value) of the SK to indicate a binary value (e.g., 0 or 1) to the receiving device. In some examples, the sequence-based signal may perform similar to an ACK or NACK used by a PUCCH format 0 signal.

In some cases, the UE 115-a may receive a message of the random access procedure that includes control information indicating the second verification bit sequence. For example, rather than configuring new verification resources, the network entity 105-a may transmit its respective verification bits to the UE 115-a over a random access procedure message (e.g., msg4 DCI 231). For example, SK verification signal 230-a and the msg4 DCI 231 may be a single transmission. In these cases, the random access procedure message may not be secured until after the respective verification bits have been transmitted. For example, if the msg4 DCI 231 includes matching verification bits, msg4 may be the first secured message. In some cases, the msg4 DCI 231 may be scrambled by the SK verification bits, and the SK verification bits may be communicated through the scrambled msg4 DCI 231. Additionally or alternatively, the SK verification bits may be transmitted in a DCI payload of the random access procedure message.

The UE 115-a, the network entity 105-a, or both may each transmit the sequence-based signal that indicates their respective verification bit sequences to a receiving device (e.g., the other device of the UE 115-a or the network entity 105-a), and the receiving device may verify the indicated verification bit sequence. For example, the UE 115-a may transmit an uplink sequence-based signal 230-b that indicates a first verification bit sequence to the network entity 105-a. The network entity 105-a may compare the first verification bit of the UE 115-a to the second verification bit of the network entity 105-a in order to determine a match or a mismatch of the bits. Additionally or alternatively, the network entity 105-a may transmit a downlink sequence-based signal 230-a that indicates a second verification bit sequence to the UE 115-a. In such an example, the UE 115-a may compare the second verification bit of the network entity 105-a to the first verification bit of the UE 115-a in order to determine a match or a mismatch.

The UE 115-a, the network entity 105-a, or both may indicate the determined match or mismatch to the other device 105-a or 110-a. In some cases (e.g., when the UE 115-a may determine the match or mismatch), the network entity 105-a may configure the UE 115-a to send or receive an acknowledgement (ACK) or non-acknowledgement (NACK) 235-b in response to the verification sequence 230-a. For example, the UE 115-a may receive additional control information from the network entity 105-a indicating resources for communicating either a match or a mismatch. In some examples, when the network entity 105-a transmits verifications bits over msg4 DCI 231, the network entity 105-a may assign one or more PUCCH resources to the UE 115-a for an ACK or NACK response 235-b to the verification bits. Additionally or alternatively, the PUCCH resources for the UE 115-a may be preconfigured and indexed with the SSB index from the network entity 105-a. The UE 115-a may determine a match between the first verification bit generated at the UE 115-a and the second verification bit transmitted by the network entity 105-a, and transmit an ACK (e.g., match) or NACK (e.g., mismatch) response 235-b to the network entity 105-a over one or more of the available resources (e.g., the assigned PUCCH resources).

In some cases, when the network entity 105-a may determine a match or mismatch between the first verification bit and the second verification, the network entity 105-a may transmit an ACK or NACK response 235-a to the UE 115-a. In these cases, the network entity 105-a may transmit the ACK or NACK 235-a over a random access procedure message (e.g., msg4 DCI 231). That is, the ACK or NACK signal 235-a and the msg4 DCI 231 may be one signal. The ACK or NACK responses 235 from the respective device may indicate whether the communications system may secure one or more remaining messages using the SK. For example, when an ACK response is transmitted and received, the SK may be used to secure the remaining messages (e.g., msg4 and subsequent messaging).

In some cases, the UE 115-a, the network entity 105-a, or both may determine a mismatch between the first verification bit and the second verification bit. In such cases, communications between the UE 115-a and the network entity 105-a may not proceed properly without establishing a match between each verification bit. The UE 115-a, the network entity 105-a, or both, may indicate a mismatch to the other communications device 105-a or 110-a. For example, the UE 115-a may transmit the SK verification bits to the network entity 105-a over verification sequence 230-b, and the network entity 105-a may determine an SK mismatch. The network entity 105-a may indicate through a random access procedure message (e.g., in msg4 DCI 231) that there is an SK mismatch, whether one or more subsequent messages unsecured based on the mismatch, or both.

In some cases, rather than automatically repeating the verification sequence to establish a match, message 231 from the network entity 105-a may indicate whether the SK may be used or may not be used to secure remaining messages. For example, the msg4 DCI 231 from the network entity 105-a may indicate to the UE 115-a (e.g., via 1 bit in a payload, an RNTI type, a CORESET, or a search space) that the SK will be used to secure one or more remaining message (e.g., msg4). That is, the message 231 may indicate that the SK agreement was correct. Alternatively if the SK agreement was not correct, and the messages are not secured, then the random access procedure may continue without using an SK. In some cases, if the random access procedure fails, the UE 115-a and the network 115-a may repeat the random access procedure. In these cases, the SK extraction procedure may be repeated during the repeated random access procedure, and the same SK or a new SK may be derived based on the steps described herein. In such cases, if a new SK is derived and the new SK agreement is correct, the communications system may switch to or back to a secured state, using the new SK for msg4 and other transmissions.

In some cases, if the SK agreement is correct, the UE 115-a and the network entity 105-a may communicate one or more messages secured (e.g., encrypted) using the SK. In some examples, the secured messages may be communicated during the random access procedure, after the random access procedure, or both. In some examples, the UE 115-a and the network entity 105-a may communicate one or more messages, after the random access procedure, indicating an update to the SK. For example, the UE 115-a, the network entity 105-a, or both may receive one or more messages that are encrypted using the agreed upon SK, indicating to update the agreed upon SK to anew SK.

In some cases, when the UE 115-a is in a connected mode (e.g., RRC) after performing initial access, the network entity 105-a may configure channel state information reference signals (CSI-RSs), sounding reference signals (SRSs) resources, or some combination thereof for SK extraction. Additionally or alternatively, the network entity 105-a may use SSBs as a reference signal for SK extraction and may configure UEs with SRS resources for uplink.

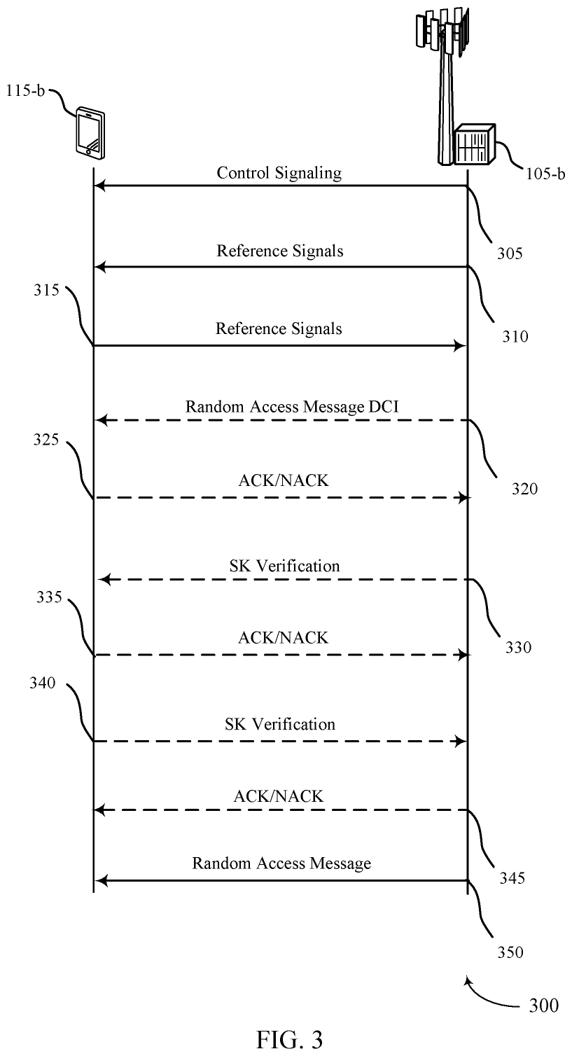

FIG. 3 illustrates an example of a process flow 300 that supports techniques for secret key extraction during an access procedure in accordance with one or more aspects of the present disclosure. The process flow 300 may implement aspects of the wireless communications system 100 and the wireless communications system 200 described with reference to FIGS. 1 and 2, respectively.

In the following description of the process flow 300, the operations between the base station 105-b and the UE 115-b may be transmitted in a different order than the example order shown, or the operations performed by the base station 105-b and the UE 115-b may be performed in different orders or at different times. Some operations may also be omitted from the process flow 300, and other operations may be added to the process flow 300. The base station 105-b and the UE 115-b may be examples of a base station 105 and UE 115 as described with reference to FIGS. 1 and 2, respectively.

During an initial access process, a UE 115-b and a network entity 105-b may perform a secret key (SK) extraction procedure over uplink and downlink communication links. For example, the UE 115-b and the network entity 105-b may use the SK extraction procedure to agree on an SK for securing subsequent transmissions.

At 305, the UE 115-b may receive, from the network entity 105-b, control information indicating that the network entity 105-b supports SK derivation associated with a random access procedure. In some examples, the UE may receive the control information 205 through MIB, SIB, OSIB, or a message of the random access procedure, or a combination thereof. The control information may indicate that the SK extraction procedure may use one or more transmissions (e.g., SSBs, a random access procedure message, or some combination thereof).

At 310, the UE 115-b may receive one or more reference signals. For example, the UE may receive one or more reference signals in a resource allocated for the transmission of a random access response message (e.g., random access message 2) during the random access procedure. Additionally or alternatively, the UE may receive one or more reference signals as SSBs over an SSB beam before performing the random access procedure. The UE 115-b may measure the one or more reference signals transmitted by the network entity 105-b to generate a first channel estimate of a wireless communication channel between the UE 115-b and the network entity 105-b. In some examples, the channel estimates may include one or more demodulation reference signal (DMRS) metrics, log likelihood ratio (LLR) metrics, or a combination thereof. The UE 115-b may derive a first SK and may generate a first verification bit sequence using the first SK.

At 315, the network entity 105-b may receive and measure one or more reference signals transmitted by the UE 115-b to generate a second channel estimate of the wireless communication channel. The network entity 105-b may derive a second SK and a second verification bit sequence using the second SK.

In some embodiments, at 320, the network entity 105-b may transmit a random access DCI message (e.g., msg4 DCI for msg4) that indicates the second verification bit sequence to the UE 115-b. In this embodiment, the receiving device may verify the indicated verification bit sequence. For example, the UE 115-b may compare the second verification bit of the network entity 105-b to the first verification bit of the UE 115-b in order to determine a match or a mismatch. At 335, the UE 115-b may transmit a response (e.g., PUCCH) to the random access DCI message. For example, based on whether the UE 115-b determines a match or a mismatch, the UE 115-b may transmit an ACK or a NACK message.

In some embodiments, at 330, the network entity 105-b may transmit an SK verification signal (e.g., separate from the random access DCI message) that indicates the second verification bit sequence to the UE 115-b. In some cases, which of the UE 115-b and the network entity 105-b that is to transmit the verification bit sequence to the other may be indicated in a specification set by a standards organization. Alternatively, the transmission of the second bit sequence may be determined or signaled by the network entity 105-b through one of a MIB, SIB, OSIB, a message of the random access procedure (e.g., msg2), or a combination thereof. In this embodiment, the receiving device may verify the indicated verification bit sequence. For example, the UE 115-b may compare the second verification bit of the network entity 105-b to the first verification bit of the UE 115-b in order to determine a match or a mismatch. At 335, the UE 115-b may transmit a response to the SK verification signal. For example, based on whether the UE 115-b determines a match or a mismatch, the UE 115-b may transmit an ACK or a NACK. In some examples, the random access DCI message may configure the resource (e.g., uplink resources) used by the UE 115-b to transmit the ACK or NACK. Alternatively, the network entity 115-b may configure the resources used by the UE 115-b to transmit the ACK or NACK through the control information at 305, one of the random access messages, the SK verification signal, or one or more other transmissions.

In some embodiments, at 340, the UE 115-b may transmit an SK verification signal that indicates the first verification bit sequence to the network entity 105-b. The network entity may compare the second verification bit of the network entity 105-b to the first verification bit of the UE 115-b in order to determine a match or a mismatch. At 345, the network entity 105-b may transmit a response to the SK verification signal. For example, based on whether the UE 115-b determines a match or a mismatch, the network entity may transmit an ACK or a NACK. In some examples, the ACK or NACK may be transmitted over the random access DCI message (e.g., msg4 DCI).

At 350, the UE 115-b and the network entity 105-b may continue the random access procedure (e.g., msg4) or subsequent communications. In some cases, if the SK agreement is correct, a match is determined, the verifying device communicates an ACK, or some combination thereof, the derived SK may be used to secure (encrypt) the subsequent communications. Alternatively, if the SK agreement is not correct, a mismatch is determined, the verifying device communicates a NACK, or some combination thereof, the subsequent communications may occur without the SK encryption.

One or more communications of the UE 115-b and the network entity 105-b may be examples of one or more random access messages of a four-step RACH procedure (e.g., msg1, msg2, msg3, and msg4) or a two-step RACH procedure (e.g., msgA and msgB). For example, in some cases, the reference signals at 310 may be included in a msg2 transmission, the reference signals at 315 may be included in a msg3 transmission, and the random access message at 350 may be included in a msg4 transmission, each transmission a step of a four-step RACH procedure. Alternatively, in a two-step RACH procedure, the reference signals at 315 may be included in a msgA transmission, and the random access message at 350 may be included in a msgB transmission. In some examples, the random access message DCI at 320 may be a DCI for a msg4 transmission (e.g., in a four-step RACH procedure) or for a msgB transmission (e.g., in a two-step RACH procedure). Additionally or alternatively, one or more messages of the four-step RACH process or two-step RACH process may not be shown.

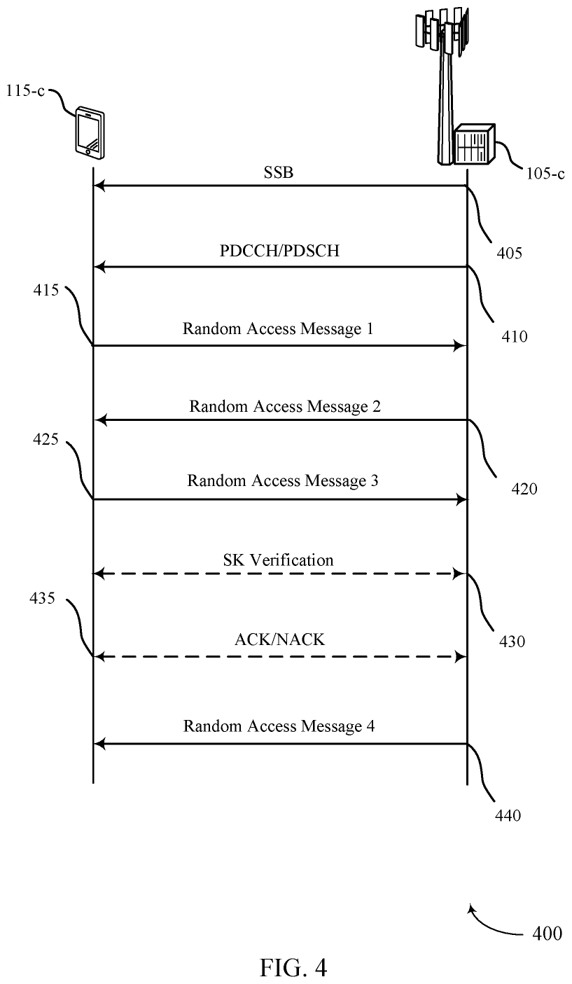

FIG. 4 illustrates an example of a process flow 400 that supports techniques for secret key extraction during an access procedure in accordance with one or more aspects of the present disclosure. The process flow 400 may implement aspects of the wireless communications system 100 and the wireless communications system 200 described with reference to FIGS. 1 and 2, respectively. Additionally or alternatively, the process flow 400 may implement aspects of the process flow 300 described with reference to FIG. 3.

In the following description of the process flow 400, the operations between the base station 105-c and the UE 115-c may be transmitted in a different order than the example order shown, or the operations performed by the base station 105-c and the UE 115-c may be performed in different orders or at different times. Some operations may also be omitted from the process flow 400, and other operations may be added to the process flow 400. The base station 105-c and the UE 115-c may be examples of a base stations 105 and UEs 115 as described with reference to FIGS. 1, 2, and 3.

During an initial access process, a UE 115-c and a network entity 105-c may perform a secret key (SK) extraction procedure over uplink and downlink communication links. For example, the UE 115-c and the network entity 105-c may use the SK extraction procedure to agree on an SK for securing subsequent transmissions.

At 405, the UE 115-c may receive, from the network entity 105-c, a transmission (e.g., synchronization signal, SSB beam) including an SSB. The SSB may include a primary synchronization signal (PSS), a secondary synchronization signal (SSS), a physical broadcast channel (PBCH), or a combination thereof. In some cases, the SSB may be a reference signal used by the UE 115-c to estimate a channel between the network entity 105-c and the UE 115-c. For example, the SSB may be an example of reference signals 310 as described with reference to FIG. 3

At 410, the UE 115-c may receive, from the network entity 105-c, a PDDCH transmission, a PDSCH transmission, or some combination thereof (e.g., SIB1 or OSIB). In some cases, the transmission at 410 may indicate to the UE 115-c that the network entity 105-c supports SK derivation associated with a random access procedure. Additionally or alternatively, the transmission may indicate that the SK extraction procedure may use one or more other transmissions (e.g., SSBs, a random access procedure message, or some combination thereof). In some examples, transmission at 410 may be an example of the control information 205 or the control signaling 305 described with reference to FIGS. 2 and 3, respectively.

At 415, the network entity 105-c may receive a first random access message (e.g., msg1 over PRACH) of a random access procedure from the UE 115-c. In some cases, the first random access message may be an example of or include one or more reference signals used by the network entity 105-c to generate a channel estimate of the wireless communication channel. For example, the first random access message may be an example of or include one or more reference signals 315 as described with reference to FIG. 3.

At 420, the network entity 105-c may transmit a second random access message (e.g., msg2 over PDCCH or PDSCH) to the UE 115-c. In some cases, the second random access message may be an additional or alternative example of or include the one or more reference signals used by the UE 115-c to generate a channel estimate of the wireless communication channel. For example, the second random access message may be an example of or include one or more reference signals 320 as described with reference to FIG. 3.

At 425, the network entity 105-c may receive a third random access message (e.g., msg3 over PUSCH) from the UE 115-c. In some cases, the third random access message may be an additional or alternative example of or include one or more reference signals used by the network entity 105-c to generate a channel estimate of the wireless communication channel. For example, the third random access message may be an example of or include one or more reference signals 315 as described with reference to FIG. 3.

At 430, the network entity 105-c or the UE 115-c may begin an SK verification process. For example, the network entity 105-c may transmit an SK verification signal to the UE 115-c, the UE 115-c may transmit an SK verification signal to the network entity 105-c, or both. The SK verification signal may indicate a first verification bit sequence to the receiving device. The receiving device may compare the second verification bit of the transmitting device to the first verification bit of the receiving device in order to determine a match or a mismatch. In some cases, the SK verification at 430 may be an example of SK verification 230-a or 230-b as described with reference to FIG. 2. Additionally or alternatively, the SK verification at 430 may be an example of the SK verification at 330 or at 340, as described with reference to FIG. 3.

At 435, the network entity 105-c or the UE 115-c (e.g., whichever device received the SK verification signal) may transmit a response to the SK verification signal. For example, if the network entity 105-c or UE 115-c determines a match or a mismatch, the same device may transmit an ACK or a NACK, respectively. In some cases, the ACK/NACK at 435 may be an example of the ACK/NACK 235-a or 235-b as described with reference to FIG. 2. Additionally or alternatively, the ACK/NACK at 435 may be an example of the ACK/NACK at 325, 335, or 345, as described with reference to FIG. 3.

At 440, the UE 115-c and the network entity 105-c may continue the random access procedure or subsequent communications. For example, the network entity 115-c may transmit a fourth random access message (e.g., msg4 over PDCCH or PDSCH). In some cases, if the SK agreement is correct, a match is determined, the verifying device communicates an ACK, or some combination thereof, a derived SK may be used to secure (encrypt) the fourth random access message. Alternatively, if the SK agreement is not correct, a mismatch is determined, the verifying device communicates a NACK, or some combination thereof, the network entity may transmit the fourth random access message, subsequent communications, or both, without the SK encryption.

One or more of the random access messages of the UE 115-c and the network entity 105-c may be examples of one or more random access messages of a four-step RACH procedure (e.g., msg1, msg2, msg3, and msg4) or a two-step RACH procedure (e.g., msgA and msgB). For example, in some cases, the first random access message at 415 may be an example of a msg1 transmission, the second random access message at 420 may be an example of a msg2 transmission, the random access message at 425 may be an example of a msg3 transmission, and the random access message at 440 may be an example of a msg4 transmission, such that each transmission is a step of a four-step RACH procedure. Alternatively, in a two-step RACH procedure, the random first and third random access messages at 415 and 425 may be combined into a single msgA transmission, and the random access messages at 420 and 440 may be combined into a single msgB transmission. Additionally or alternatively, one or more messages of the four-step RACH process or two-step RACH process may not be shown.

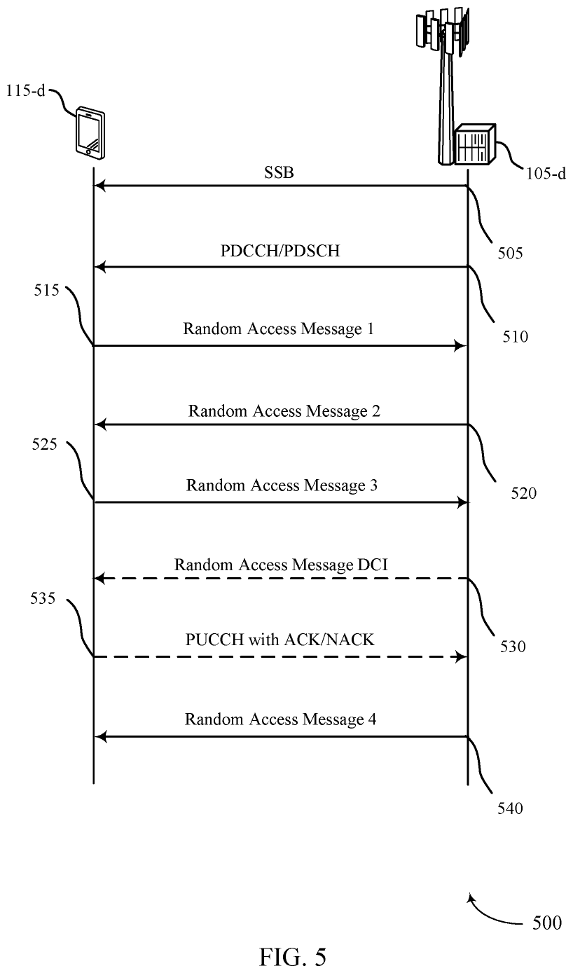

FIG. 5 illustrates an example of a process flow 500 that supports techniques for secret key extraction during an access procedure in accordance with one or more aspects of the present disclosure. The process flow 500 may implement aspects of the wireless communications system 100 and the wireless communications system 200 described with reference to FIGS. 1 and 2, respectively. Additionally or alternatively, the process flow 500 may implement aspects of the process flows 300 and 400 described with reference to FIGS. 3 and 4, respectively.

In the following description of the process flow 500, the operations between the base station 105-d and the UE 115-d may be transmitted in a different order than the example order shown, or the operations performed by the base station 105-d and the UE 115-d may be performed in different orders or at different times. Some operations may also be omitted from the process flow 500, and other operations may be added to the process flow 500. The base station 105-d and the UE 115-d may be examples of a base stations 105 and UEs 115 as described with reference to FIGS. 1, 2, 3, and 4.

During an initial access process, a UE 115-d and a network entity 105-d may perform a secret key (SK) extraction procedure over uplink and downlink communication links. For example, the UE 115-d and the network entity 105-d may use the SK extraction procedure to agree on an SK for securing subsequent transmissions.

At 505, the UE 115-d may receive, from the network entity 105-d, a transmission (e.g., synchronization signal, SSB beam) including an SSB. The SSB may include a primary synchronization signal (PSS), a secondary synchronization signal (SSS), a physical broadcast channel (PBCH), or a combination thereof. In some cases, the SSB may be a reference signal used by the UE 115-d to estimate a channel between the network entity 105-d and the UE 115-d. In some cases, the SSB may be an example of reference signals 310 as described with reference to FIG. 3

At 510, the UE 115-d may receive, from the network entity 105-d, a PDDCH transmission, a PDSCH transmission, or some combination thereof (e.g., SIB1 or OSIB). In some cases, the transmission at 510 may indicate to the UE 115-d that the network entity 105-d supports SK derivation associated with a random access procedure. Additionally or alternatively, the transmission may indicate that the SK extraction procedure may use one or more other transmissions (e.g., SSBs, a random access procedure message, or some combination thereof). In some examples, transmission at 510 may be an example of the control information 205 or the control signaling 305 described with reference to FIGS. 2 and 3, respectively.

At 515, the network entity 105-d may receive a first random access message (e.g., msg1 over PRACH) of a random access procedure from the UE 115-d. In some cases, the first random access message may be an example of or include one or more reference signals used by the network entity 105-d to generate a channel estimate of the wireless communication channel. For example, the first random access message may be an example of or include one or more reference signals 315 as described with reference to FIG. 3.

At 520, the network entity 105-d may transmit a second random access message (e.g., msg2 over PDCCH or PDSCH) to the UE 115-d. In some cases, the second random access message may be an additional or alternative example of the one or more reference signals used by the UE 115-d to generate a channel estimate of the wireless communication channel. For example, the second random access message may be an example of or include one or more reference signals 320 as described with reference to FIG. 3.

At 525, the network entity 105-d may receive a third random access message (e.g., msg3 over PUSCH) from the UE 115-d. In some cases, the third random access message may be an additional or alternative example of or include one or more reference signals used by the network entity 105-d to generate a channel estimate of the wireless communication channel. For example, the third random access message may be an example of or include one or more reference signals 315 as described with reference to FIG. 3.

At 530, the network entity 105-d may transmit a DCI for a random access message (e.g., for msg4) to begin an SK verification process. For example, the DCI message may include one or more verification bits of a verification bit sequence derived by the network entity 105-d, based on the generated channel estimate at network entity 105-d. The UE 115-d may compare the received verification bits of the network entity 105-d to its own verification bits in order to determine a match or a mismatch. In some cases, the SK verification associated with the DCI message at 530 may be an example of the SK verification 230-a or 230-b as described with reference to FIG. 2. Additionally or alternatively, the SK verification associated with the DCI message at 530 may be an example of the SK verification at 330 or at 340, as described with reference to FIG. 3.

At 535, the UE 115-d may transmit a response to the SK verification signal. For example, if the UE 115-d determines a match or a mismatch, it may transmit an ACK or a NACK, respectively, on the verification bits. In some cases, the ACK/NACK at 535 may be an example of the ACK/NACK 235-a or 235-b as described with reference to FIG. 2. Additionally or alternatively, the ACK/NACK at 535 may be an example of the ACK/NACK at 325, 335, or 345, as described with reference to FIG. 3.

At 540, the UE 115-c and the network entity 105-d may continue the random access procedure or subsequent communications. For example, the network entity 115-d may transmit a fourth random access message (e.g., msg4 over PDCCH or PDSCH). In some cases, if the SK agreement is correct, a match is determined, the verifying device communicates an ACK, or some combination thereof, a derived SK may be used to secure (encrypt) the fourth random access message. Alternatively, if the SK agreement is not correct, a mismatch is determined, the verifying device communicates a NACK, or some combination thereof, the network entity may transmit the fourth random access message, subsequent communications, or both, without the SK encryption.

One or more of the random access messages of the UE 115-d and the network entity 105-d may be examples of one or more random access messages of a four-step RACH procedure (e.g., msg1, msg2, msg3, and msg4) or a two-step RACH procedure (e.g., msgA and msgB). For example, in some cases, the first random access message at 515 may be an example of a msg1 transmission, the second random access message at 520 may be an example of a msg2 transmission, the random access message at 525 may be an example of a msg3 transmission, and the random access message at 540 may be an example of a msg4 transmission, such that each transmission is a step of a four-step RACH procedure. Alternatively, in a two-step RACH procedure, the random first and third random access messages at 515 and 525 may be combined into a single msgA transmission, and the random access messages at 520 and 540 may be combined into a single msgB transmission. In some examples, the random access message DCI at 530 may be a DCI for a msg4 transmission (e.g., in a four-step RACH procedure) or for a msgB transmission (e.g., in a two-step RACH procedure). Additionally or alternatively, one or more messages of the four-step RACH process or two-step RACH process may not be shown.

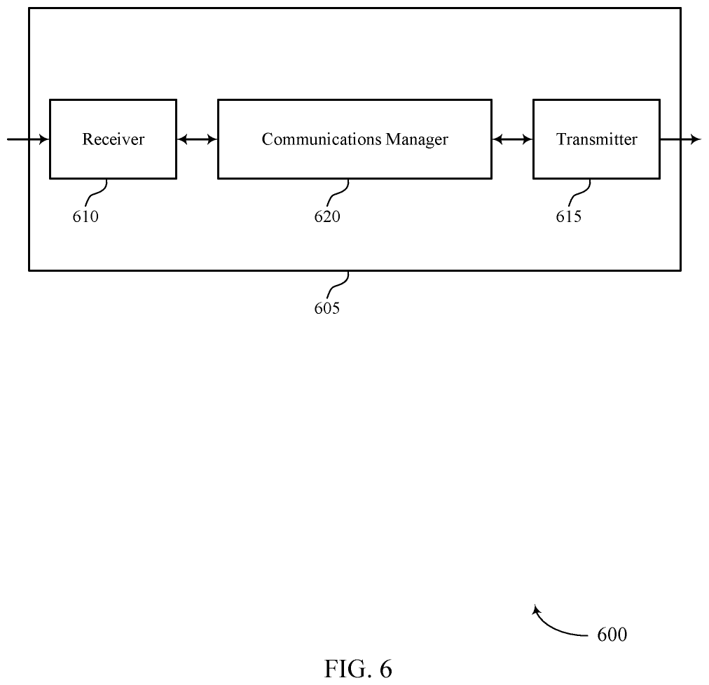

FIG. 6 shows a block diagram 600 of a device 605 that supports techniques for secret key extraction during an access procedure in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for secret key extraction during an access procedure). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for secret key extraction during an access procedure). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for secret key extraction during an access procedure as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving control information indicating that a network entity supports key derivation associated with a random access procedure with the network entity. The communications manager 620 may be configured as or otherwise support a means for measuring, based on the control information, one or more reference signals transmitted by the network entity during or prior to the random access procedure to generate a channel estimate of a wireless communication channel between the UE and the network entity. The communications manager 620 may be configured as or otherwise support a means for communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for secret key extraction during an access procedure, which may result in more efficient utilization of communication resources, improved security, or both, among other benefits.

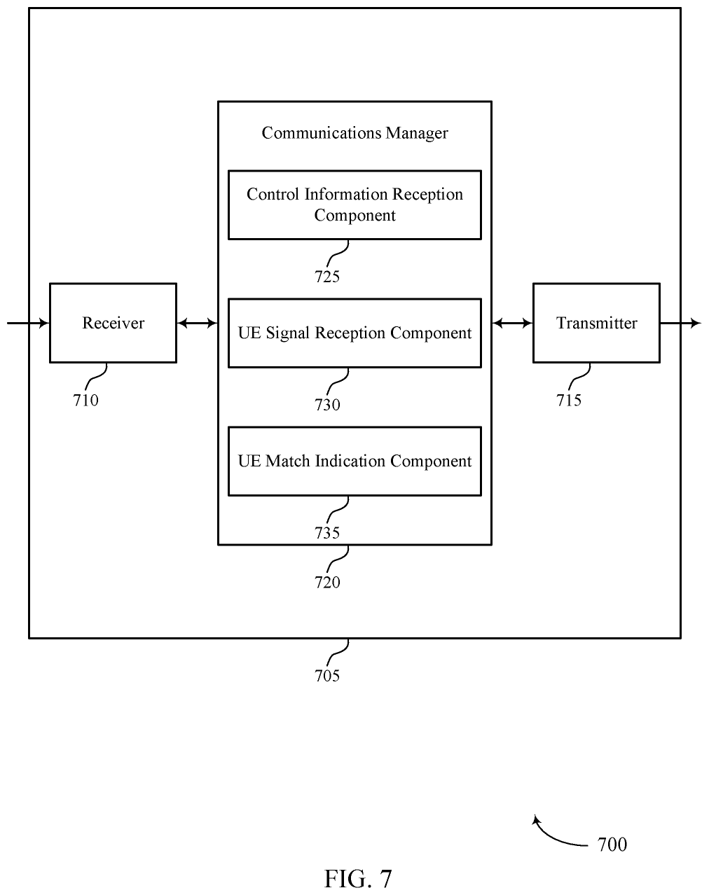

FIG. 7 shows a block diagram 700 of a device 705 that supports techniques for secret key extraction during an access procedure in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for secret key extraction during an access procedure). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for secret key extraction during an access procedure). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for secret key extraction during an access procedure as described herein. For example, the communications manager 720 may include a control information reception component 725, a UE signal reception component 730, a UE match indication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The control information reception component 725 may be configured as or otherwise support a means for receiving control information indicating that a network entity supports key derivation associated with a random access procedure with the network entity. The UE signal reception component 730 may be configured as or otherwise support a means for measuring, based on the control information, one or more reference signals transmitted by the network entity during or prior to the random access procedure to generate a channel estimate of a wireless communication channel between the UE and the network entity. The UE match indication component 735 may be configured as or otherwise support a means for communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

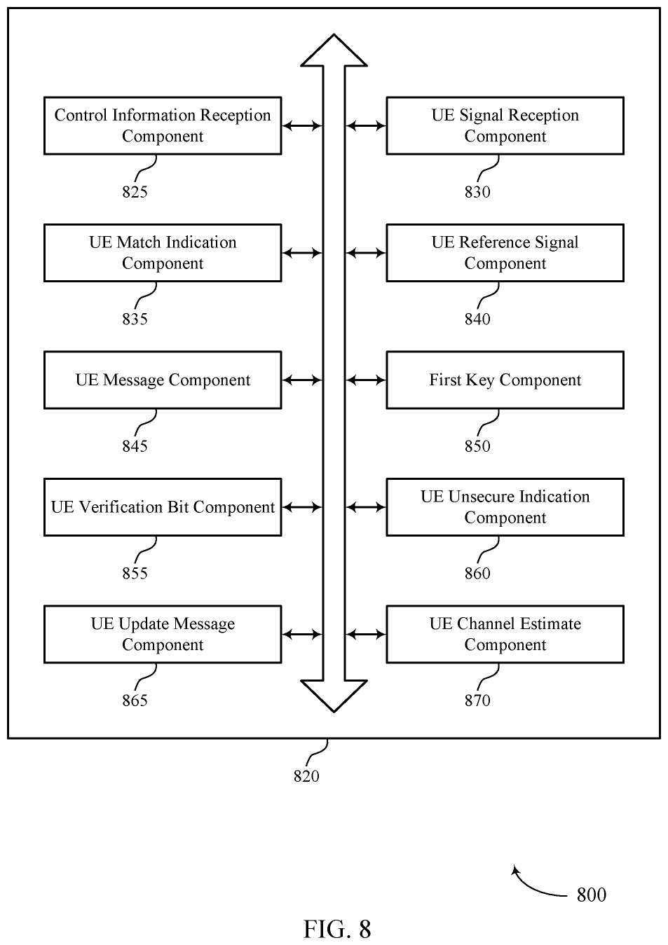

FIG. 8 shows a block diagram 800 of a communications manager 820 that supports techniques for secret key extraction during an access procedure in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for secret key extraction during an access procedure as described herein. For example, the communications manager 820 may include a control information reception component 825, a UE signal reception component 830, a UE match indication component 835, a UE reference signal component 840, a UE message component 845, a first key component 850, a UE verification bit component 855, a UE unsecure indication component 860, a UE update message component 865, a UE channel estimate component 870, or any combination thereof. Each of these components may communicate, directly or indirectly, with one another (e.g., via one or more buses).

The communications manager 820 may support wireless communications at a UE in accordance with examples as disclosed herein. The control information reception component 825 may be configured as or otherwise support a means for receiving control information indicating that a network entity supports key derivation associated with a random access procedure with the network entity. The UE signal reception component 830 may be configured as or otherwise support a means for measuring, based on the control information, one or more reference signals transmitted by the network entity during or prior to the random access procedure to generate a channel estimate of a wireless communication channel between the UE and the network entity. The UE match indication component 835 may be configured as or otherwise support a means for communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

In some examples, the UE reference signal component 840 may be configured as or otherwise support a means for receiving the one or more reference signals in a resource allocated for transmission of a random access response message of the random access procedure.

In some examples, the UE message component 845 may be configured as or otherwise support a means for communicating one or more messages secured using the first key derived from the channel estimate based on communicating the indication of a match between the first verification bit sequence and the second verification bit sequence, the one or more messages communicated during the random access procedure, after the random access procedure, or both.

In some examples, the UE message component 845 may be configured as or otherwise support a means for communicating a message of the random access procedure that has a quasi co-location relationship with the one or more reference signals.

In some examples, to support receiving the control information, the control information reception component 825 may be configured as or otherwise support a means for receiving the control information via a master information block, a system information block, a message of the random access procedure, or any combination thereof.

In some examples, the control information reception component 825 may be configured as or otherwise support a means for receiving second control information indicating a metric associated with measuring the channel estimate. In some examples, the first key component 850 may be configured as or otherwise support a means for obtaining the first key using the metric associated with the channel estimate.

In some examples, the UE verification bit component 855 may be configured as or otherwise support a means for communicating a signal indicating the first verification bit sequence or the second verification bit sequence, where communicating the indication of the match or the mismatch is based on communicating the signal.

In some examples, the control information reception component 825 may be configured as or otherwise support a means for receiving second control information indicating a resource for communicating the indication of one of the match or the mismatch.

In some examples, the UE message component 845 may be configured as or otherwise support a means for receiving a message of the random access procedure, the message including control information indicating the second verification bit sequence.

In some examples, the UE match indication component 835 may be configured as or otherwise support a means for communicating the indication of the mismatch between the first verification bit sequence and the second verification bit sequence. In some examples, the UE unsecure indication component 860 may be configured as or otherwise support a means for receiving a message of the random access procedure indicating whether one or more subsequent messages communicated between the UE and the network entity are unsecured based on the mismatch.

In some examples, the UE update message component 865 may be configured as or otherwise support a means for communicating one or more messages subsequent to the random access procedure that are encrypted using the first key, the one or more messages indicating to update the first key to a third key.

In some examples, the first key component 850 may be configured as or otherwise support a means for obtaining the first key using the channel estimate of the wireless communication channel, where communicating the indication of one of the match or the mismatch is based on obtaining the first key.

In some examples, the UE reference signal component 840 may be configured as or otherwise support a means for receiving the one or more reference signals prior to the random access procedure, where measuring the one or more reference signals is based on receiving the one or more reference signals.

In some examples, the UE channel estimate component 870 may be configured as or otherwise support a means for generating the channel estimate based on measuring the one or more reference signals, the channel estimate including a demodulation reference signal metric, a log likelihood ratio metric, or a combination thereof.

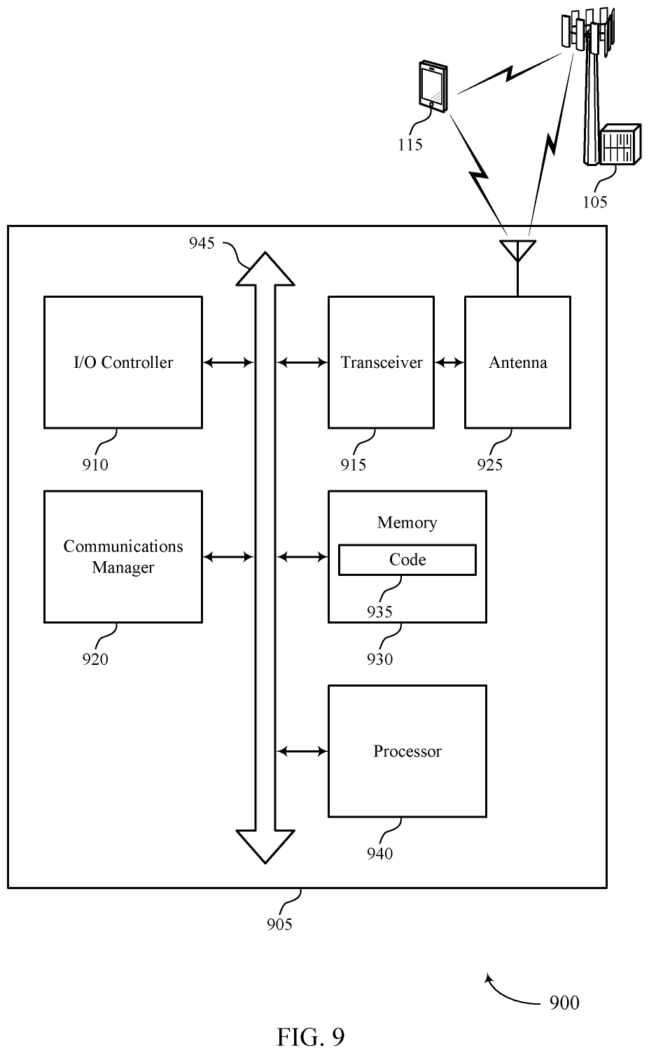

FIG. 9 shows a diagram of a system 900 including a device 905 that supports techniques for secret key extraction during an access procedure in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for secret key extraction during an access procedure). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving control information indicating that a network entity supports key derivation associated with a random access procedure with the network entity. The communications manager 920 may be configured as or otherwise support a means for measuring, based on the control information, one or more reference signals transmitted by the network entity during or prior to the random access procedure to generate a channel estimate of a wireless communication channel between the UE and the network entity. The communications manager 920 may be configured as or otherwise support a means for communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

By including or configuring the communications manager 920 in accordance with examples as described herein, the device 905 may support techniques for secret key extraction during an access procedure, which may result in more efficient utilization of communication resources, improved coordination between devices, improved security, or both, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for secret key extraction during an access procedure as described herein, or the processor 940 and the memory 930 may be otherwise configured to perform or support such operations.

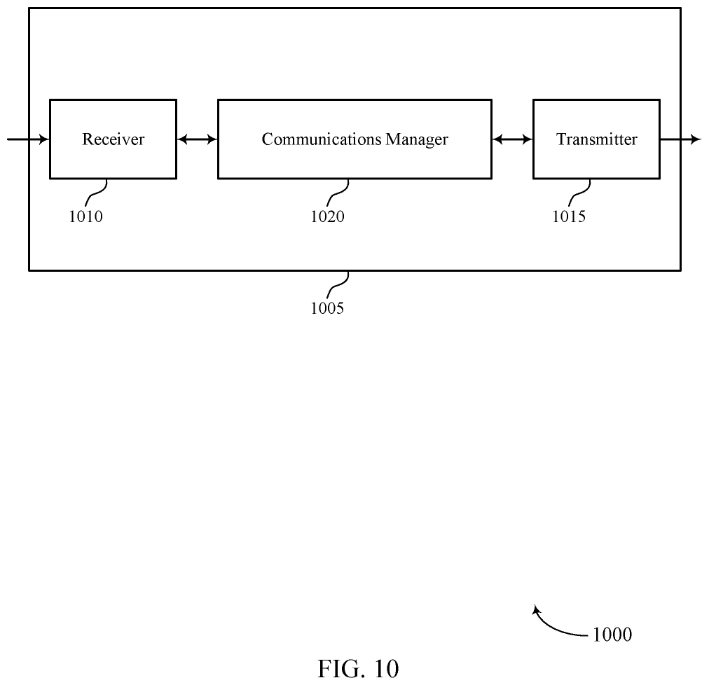

FIG. 10 shows a block diagram 1000 of a device 1005 that supports techniques for secret key extraction during an access procedure in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for secret key extraction during an access procedure as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting control information indicating that the network entity supports key derivation associated with a random access procedure with the network entity. The communications manager 1020 may be configured as or otherwise support a means for measuring, based on the control information, one or more reference signals transmitted by a UE during the random access procedure to generate a channel estimate of a wireless communication channel between the UE and the network entity. The communications manager 1020 may be configured as or otherwise support a means for communicating, during the random access procedure, an indication of one of a match or a mismatch between a first verification bit sequence generated by the UE using a first key derived by the UE and a second verification bit sequence using a second key derived from the channel estimate by the network entity.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for secret key extraction during an access procedure, which may result in more efficient utilization of communication resources, improved coordination between devices, improved security, or both, among other benefits.

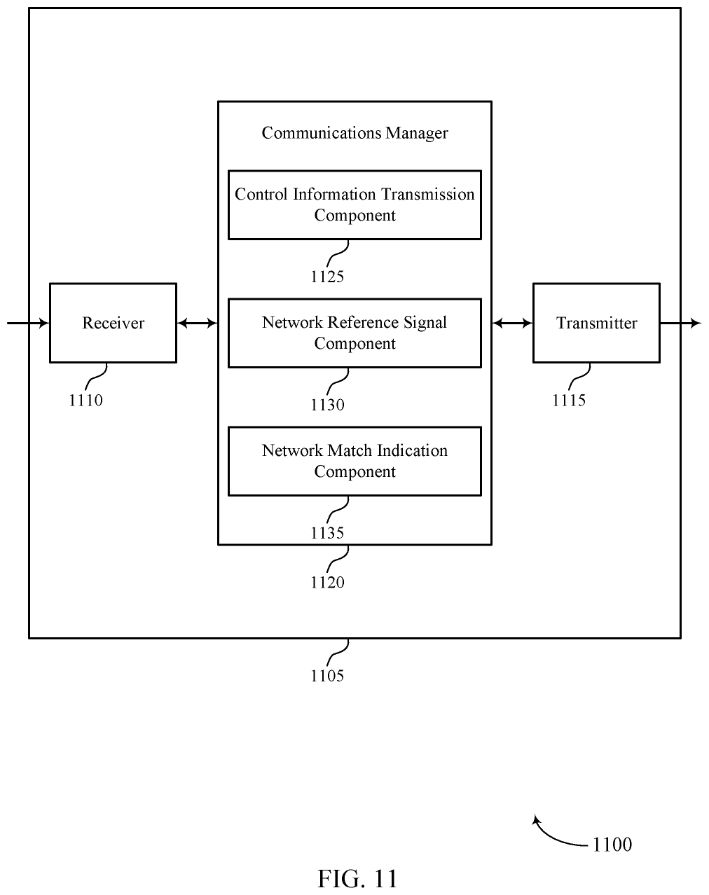

FIG. 11 shows a block diagram 1100 of a device 1105 that supports techniques for secret key extraction during an access procedure in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for secret key extraction during an access procedure as described herein. For example, the communications manager 1120 may include a control information transmission component 1125, a network reference signal component 1130, a network match indication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The control information transmission component 1125 may be configured as or otherwise support a means for transmitting control information indicating that the network entity supports key derivation associated with a random access procedure with the network entity. The network reference signal component 1130 may be configured as or otherwise support a means for measuring, based on the control information, one or more reference signals transmitted by a UE during the random access procedure to generate a channel estimate of a wireless communication channel between the UE and the network entity. The network match indication component 1135 may be configured as or otherwise support a means for communicating, during the random access procedure, an indication of one of a match or a mismatch between a first verification bit sequence generated by the UE using a first key derived by the UE and a second verification bit sequence using a second key derived from the channel estimate by the network entity.

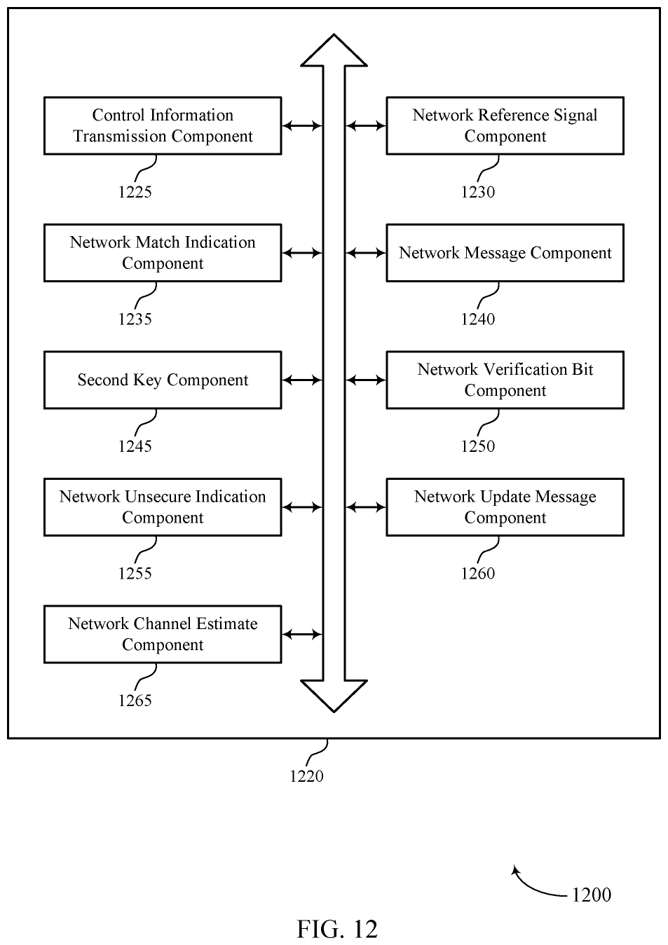

FIG. 12 shows a block diagram 1200 of a communications manager 1220 that supports techniques for secret key extraction during an access procedure in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for secret key extraction during an access procedure as described herein. For example, the communications manager 1220 may include a control information transmission component 1225, a network reference signal component 1230, a network match indication component 1235, a network message component 1240, a second key component 1245, a network verification bit component 1250, a network unsecure indication component 1255, a network update message component 1260, a network channel estimate component 1265, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The control information transmission component 1225 may be configured as or otherwise support a means for transmitting control information indicating that the network entity supports key derivation associated with a random access procedure with the network entity. The network reference signal component 1230 may be configured as or otherwise support a means for measuring, based on the control information, one or more reference signals transmitted by a UE during the random access procedure to generate a channel estimate of a wireless communication channel between the UE and the network entity. The network match indication component 1235 may be configured as or otherwise support a means for communicating, during the random access procedure, an indication of one of a match or a mismatch between a first verification bit sequence generated by the UE using a first key derived by the UE and a second verification bit sequence using a second key derived from the channel estimate by the network entity.

In some examples, the network reference signal component 1230 may be configured as or otherwise support a means for transmitting the one or more reference signals in a resource allocated for transmission of a random access response message of the random access procedure.

In some examples, the network message component 1240 may be configured as or otherwise support a means for communicating one or more messages secured using the second key derived from the channel estimate based on communicating the indication of a match between the first verification bit sequence and the second verification bit sequence, the one or more messages communicated during the random access procedure, after the random access procedure, or both.

In some examples, the network message component 1240 may be configured as or otherwise support a means for communicating a message of the random access procedure that has a quasi co-location relationship with the one or more reference signals.

In some examples, to support transmitting the control information, the control information transmission component 1225 may be configured as or otherwise support a means for transmitting the control information via a master information block, a system information block, a message of the random access procedure, or any combination thereof.

In some examples, the control information transmission component 1225 may be configured as or otherwise support a means for transmitting second control information indicating a metric associated with the measuring channel estimate. In some examples, the second key component 1245 may be configured as or otherwise support a means for obtaining the second key using the metric associated with the channel estimate.

In some examples, the network verification bit component 1250 may be configured as or otherwise support a means for communicating a signal indicating the first verification bit sequence or the second verification bit sequence, where communicating the indication of the match or the mismatch is based on communicating the signal.

In some examples, the control information transmission component 1225 may be configured as or otherwise support a means for transmitting second control information indicating a resource for communicating the indication of one of the match or the mismatch.

In some examples, the network message component 1240 may be configured as or otherwise support a means for transmitting a message of the random access procedure, the message including control information indicating the second verification bit sequence.

In some examples, the network match indication component 1235 may be configured as or otherwise support a means for communicating the indication of the mismatch between the first verification bit sequence and the second verification bit sequence. In some examples, the network unsecure indication component 1255 may be configured as or otherwise support a means for transmitting a message of the random access procedure indicating whether one or more subsequent messages communicated between the UE and the network entity are unsecured based on the mismatch.

In some examples, the network update message component 1260 may be configured as or otherwise support a means for communicating one or more messages subsequent to the random access procedure that are encrypted using the first key, the one or more messages indicating to update the first key to a third key.

In some examples, the second key component 1245 may be configured as or otherwise support a means for obtaining the second key using the channel estimate of the wireless communication channel, where communicating the indication of one of the match or the mismatch is based on obtaining the second key.

In some examples, the network reference signal component 1230 may be configured as or otherwise support a means for transmitting the one or more reference signals prior to the random access procedure, where measuring the one or more reference signals is based on transmitting the one or more reference signals.

In some examples, the network channel estimate component 1265 may be configured as or otherwise support a means for generating the channel estimate based on measuring the one or more reference signals, the channel estimate including a demodulation reference signal metric, a log likelihood ratio metric, or a combination thereof.

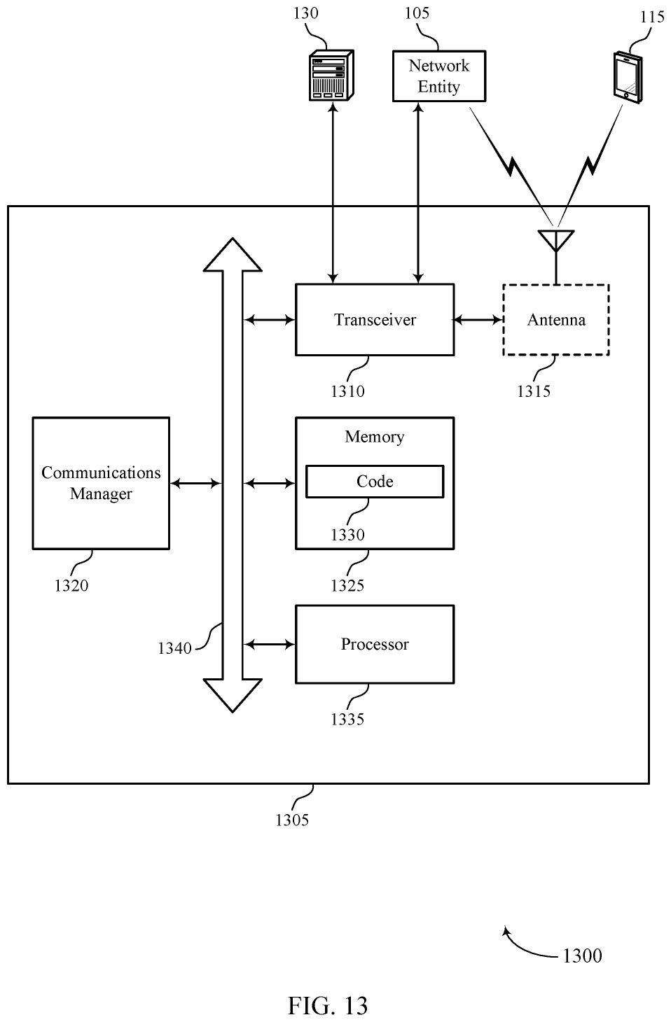

FIG. 13 shows a diagram of a system 1300 including a device 1305 that supports techniques for secret key extraction during an access procedure in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for secret key extraction during an access procedure). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting control information indicating that the network entity supports key derivation associated with a random access procedure with the network entity. The communications manager 1320 may be configured as or otherwise support a means for measuring, based on the control information, one or more reference signals transmitted by a UE during the random access procedure to generate a channel estimate of a wireless communication channel between the UE and the network entity. The communications manager 1320 may be configured as or otherwise support a means for communicating, during the random access procedure, an indication of one of a match or a mismatch between a first verification bit sequence generated by the UE using a first key derived by the UE and a second verification bit sequence using a second key derived from the channel estimate by the network entity.

By including or configuring the communications manager 1320 in accordance with examples as described herein, the device 1305 may support techniques for secret key extraction during an access procedure, which may result in more efficient utilization of communication resources, improved coordination between devices, improved security, or both, among other benefits.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for secret key extraction during an access procedure as described herein, or the processor 1335 and the memory 1325 may be otherwise configured to perform or support such operations.

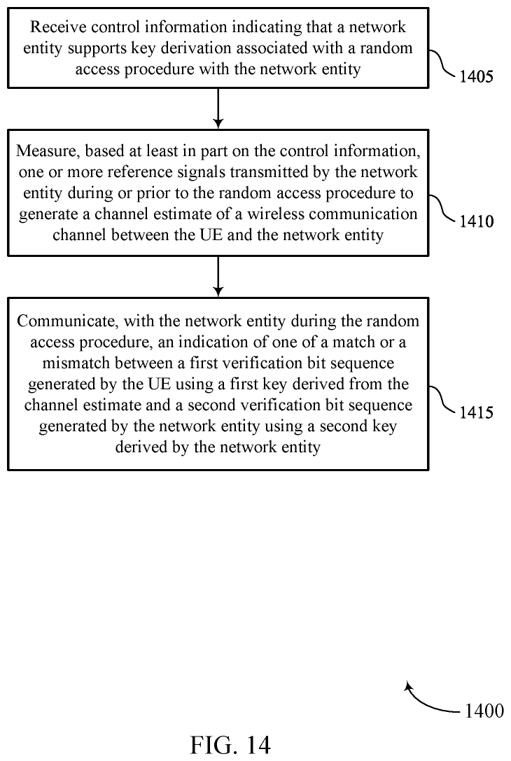

FIG. 14 shows a flowchart illustrating a method 1400 that supports techniques for secret key extraction during an access procedure in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control information indicating that a network entity supports key derivation associated with a random access procedure with the network entity. The operations of 1405 may be performed in accordance with examples as disclosed herein. In some examples, aspects of the operations of 1405 may be performed by a control information reception component 825 as described with reference to FIG. 8.

At 1410, the method may include measuring, based on the control information, one or more reference signals transmitted by the network entity during or prior to the random access procedure to generate a channel estimate of a wireless communication channel between the UE and the network entity. The operations of 1410 may be performed in accordance with examples as disclosed herein. In some examples, aspects of the operations of 1410 may be performed by a UE signal reception component 830 as described with reference to FIG. 8.

At 1415, the method may include communicating, with the network entity during the random access procedure, an indication of one of a match or a mismatch between a first verification bit sequence generated by the UE using a first key derived from the channel estimate and a second verification bit sequence generated by the network entity using a second key derived by the network entity. The operations of 1415 may be performed in accordance with examples as disclosed herein. In some examples, aspects of the operations of 1415 may be performed by a UE match indication component 835 as described with reference to FIG. 8.

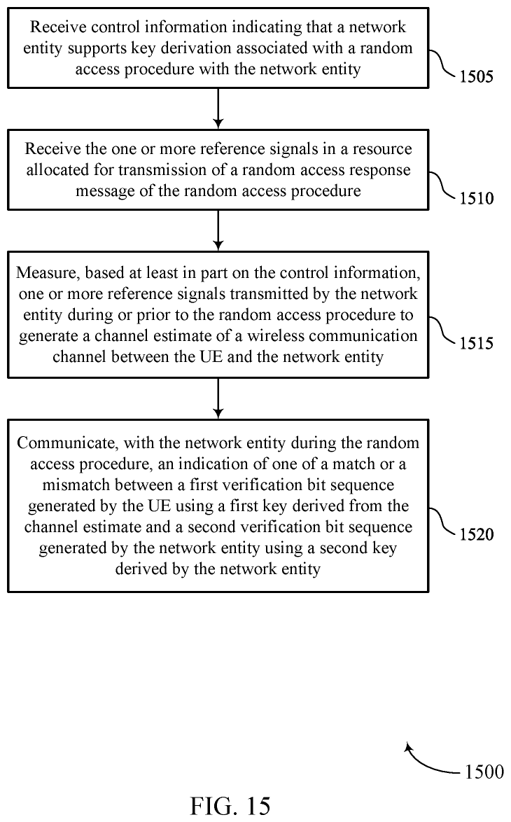

FIG. 15 shows a flowchart illustrating a method 1500 that supports techniques for secret key extraction during an access procedure in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving control information indicating that a network entity supports key derivation associated with a random access procedure with the network entity. The operations of 1505 may be performed in accordance with examples as disclosed herein. In some examples, aspects of the operations of 1505 may be performed by a control information reception component 825 as described with reference to FIG. 8.

At 1510, the method may include receiving the one or more reference signals in a resource allocated for transmission of a random access response message of the random access procedure. The operations of 1510 may be performed in accordance with examples as disclosed herein. In some examples, aspects of the operations of 1510 may be performed by a UE reference signal component 840 as described with reference to FIG. 8.

At 1515, the method may include measuring, based on the control information, one or more reference signals transmitted by the network entity during or prior to the random access procedure to generate a channel estimate of a wireless communication channel between the UE and the network entity. The operations of 1515 may be performed in accordance with examples as disclosed herein. In some examples, aspects of the operations of 1515 may be performed by a UE signal reception component 830 as described with reference to FIG. 8.

At 1520, the method may include communicating, with the network entity during the random access procedure, an indication of one of a match or a mismatch between a first verification bit sequence generated by the UE using a first key derived from the channel estimate and a second verification bit sequence generated by the network entity using a second key derived by the network entity. The operations of 1520 may be performed in accordance with examples as disclosed herein. In some examples, aspects of the operations of 1520 may be performed by a UE match indication component 835 as described with reference to FIG. 8.

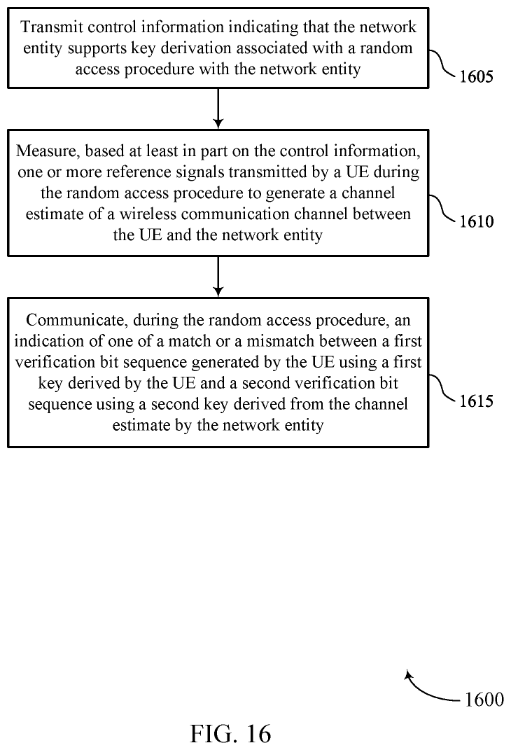

FIG. 16 shows a flowchart illustrating a method 1600 that supports techniques for secret key extraction during an access procedure in accordance with one or more aspects of the present disclosure. The operations of the method 1600 may be implemented by a network entity or its components as described herein. For example, the operations of the method 1600 may be performed by a network entity as described with reference to FIGS. 1 through 3 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control information indicating that the network entity supports key derivation associated with a random access procedure with the network entity. The operations of 1605 may be performed in accordance with examples as disclosed herein. In some examples, aspects of the operations of 1605 may be performed by a control information transmission component 1225 as described with reference to FIG. 12.

At 1610, the method may include measuring, based on the control information, one or more reference signals transmitted by a UE during the random access procedure to generate a channel estimate of a wireless communication channel between the UE and the network entity. The operations of 1610 may be performed in accordance with examples as disclosed herein. In some examples, aspects of the operations of 1610 may be performed by a network reference signal component 1230 as described with reference to FIG. 12.

At 1615, the method may include communicating, during the random access procedure, an indication of one of a match or a mismatch between a first verification bit sequence generated by the UE using a first key derived by the UE and a second verification bit sequence using a second key derived from the channel estimate by the network entity. The operations of 1615 may be performed in accordance with examples as disclosed herein. In some examples, aspects of the operations of 1615 may be performed by a network match indication component 1235 as described with reference to FIG. 12.

The following provides an overview of aspects of the present disclosure:

Aspect 1: A method for wireless communications at a UE, comprising: receiving control information indicating that a network entity supports key derivation associated with a random access procedure with the network entity; measuring, based at least in part on the control information, one or more reference signals transmitted by the network entity during or prior to the random access procedure to generate a channel estimate of a wireless communication channel between the UE and the network entity; and communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

Aspect 2: The method of aspect 1, further comprising: receiving the one or more reference signals in a resource allocated for transmission of a random access response message of the random access procedure.

Aspect 3: The method of any of aspects 1 through 2, further comprising: communicating one or more messages secured using the first key derived from the channel estimate based at least in part on communicating the indication of a match between the first verification bit sequence and the second verification bit sequence, the one or more messages communicated during the random access procedure, after the random access procedure, or both.

Aspect 4: The method of any of aspects 1 through 3, further comprising: communicating a message of the random access procedure that has a quasi co-location relationship with the one or more reference signals.

Aspect 5: The method of any of aspects 1 through 4, wherein receiving the control information comprises: receiving the control information via a master information block, a system information block, a message of the random access procedure, or any combination thereof.

Aspect 6: The method of any of aspects 1 through 5, further comprising: receiving second control information indicating a metric associated with measuring the channel estimate; and obtaining the first key using the metric associated with the channel estimate.

Aspect 7: The method of any of aspects 1 through 6, further comprising: communicating a signal indicating the first verification bit sequence or the second verification bit sequence, wherein communicating the indication of the match or the mismatch is based at least in part on communicating the signal.

Aspect 8: The method of any of aspects 1 through 7, further comprising: receiving second control information indicating a resource for communicating the indication of one of the match or the mismatch.

Aspect 9: The method of any of aspects 1 through 8, further comprising: receiving a message of the random access procedure, the message comprising control information indicating the second verification bit sequence.

Aspect 10: The method of any of aspects 1 through 9, further comprising: communicating the indication of the mismatch between the first verification bit sequence and the second verification bit sequence; and receiving a message of the random access procedure indicating whether one or more subsequent messages communicated between the UE and the network entity are unsecured based at least in part on the mismatch.

Aspect 11: The method of any of aspects 1 through 10, further comprising: communicating one or more messages subsequent to the random access procedure that are encrypted using the first key, the one or more messages indicating to update the first key to a third key.

Aspect 12: The method of any of aspects 1 through 11, further comprising: obtaining the first key using the channel estimate of the wireless communication channel, wherein communicating the indication of one of the match or the mismatch is based at least in part on obtaining the first key.

Aspect 13: The method of any of aspects 1 through 12, further comprising: receiving the one or more reference signals prior to the random access procedure, wherein measuring the one or more reference signals is based at least in part on receiving the one or more reference signals.

Aspect 14: The method of any of aspects 1 through 13, further comprising: generating the channel estimate based at least in part on measuring the one or more reference signals, the channel estimate comprising a demodulation reference signal metric, a log likelihood ratio metric, or a combination thereof.

Aspect 15: A method for wireless communications at a network entity, comprising: transmitting control information indicating that the network entity supports key derivation associated with a random access procedure with the network entity; measuring, based at least in part on the control information, one or more reference signals transmitted by a UE during the random access procedure to generate a channel estimate of a wireless communication channel between the UE and the network entity; and communicating, during the random access procedure, an indication of one of a match or a mismatch between a first verification bit sequence generated by the UE using a first key derived by the UE and a second verification bit sequence using a second key derived from the channel estimate by the network entity.

Aspect 16: The method of aspect 15, further comprising: transmitting the one or more reference signals in a resource allocated for transmission of a random access response message of the random access procedure.

Aspect 17: The method of any of aspects 15 through 16, further comprising: communicating one or more messages secured using the second key derived from the channel estimate based at least in part on communicating the indication of a match between the first verification bit sequence and the second verification bit sequence, the one or more messages communicated during the random access procedure, after the random access procedure, or both.

Aspect 18: The method of any of aspects 15 through 17, further comprising: communicating a message of the random access procedure that has a quasi co-location relationship with the one or more reference signals.

Aspect 19: The method of any of aspects 15 through 18, wherein transmitting the control information comprises: transmitting the control information via a master information block, a system information block, a message of the random access procedure, or any combination thereof.

Aspect 20: The method of any of aspects 15 through 19, further comprising: transmitting second control information indicating a metric associated with the measuring channel estimate; and obtaining the second key using the metric associated with the channel estimate.

Aspect 21: The method of any of aspects 15 through 20, further comprising: communicating a signal indicating the first verification bit sequence or the second verification bit sequence, wherein communicating the indication of the match or the mismatch is based at least in part on communicating the signal.

Aspect 22: The method of any of aspects 15 through 21, further comprising: transmitting second control information indicating a resource for communicating the indication of one of the match or the mismatch.

Aspect 23: The method of any of aspects 15 through 22, further comprising: transmitting a message of the random access procedure, the message comprising control information indicating the second verification bit sequence.

Aspect 24: The method of any of aspects 15 through 23, further comprising: communicating the indication of the mismatch between the first verification bit sequence and the second verification bit sequence; and transmitting a message of the random access procedure indicating whether one or more subsequent messages communicated between the UE and the network entity are unsecured based at least in part on the mismatch.

Aspect 25: The method of any of aspects 15 through 24, further comprising: communicating one or more messages subsequent to the random access procedure that are encrypted using the first key, the one or more messages indicating to update the first key to a third key.

Aspect 26: The method of any of aspects 15 through 25, further comprising: obtaining the second key using the channel estimate of the wireless communication channel, wherein communicating the indication of one of the match or the mismatch is based at least in part on obtaining the second key.

Aspect 27: The method of any of aspects 15 through 26, further comprising: transmitting the one or more reference signals prior to the random access procedure, wherein measuring the one or more reference signals is based at least in part on transmitting the one or more reference signals.

Aspect 28: The method of any of aspects 15 through 27, further comprising: generating the channel estimate based at least in part on measuring the one or more reference signals, the channel estimate comprising a demodulation reference signal metric, a log likelihood ratio metric, or a combination thereof.

Aspect 29: An apparatus for wireless communications at a UE, comprising a processor; memory coupled with the processor; and instructions stored in the memory and executable by the processor to cause the apparatus to perform a method of any of aspects 1 through 14.

Aspect 30: An apparatus for wireless communications at a UE, comprising at least one means for performing a method of any of aspects 1 through 14.

Aspect 31: A non-transitory computer-readable medium storing code for wireless communications at a UE, the code comprising instructions executable by a processor to perform a method of any of aspects 1 through 14.

Aspect 32: An apparatus for wireless communications at a network entity, comprising a processor; memory coupled with the processor; and instructions stored in the memory and executable by the processor to cause the apparatus to perform a method of any of aspects 15 through 28.

Aspect 33: An apparatus for wireless communications at a network entity, comprising at least one means for performing a method of any of aspects 15 through 28.

Aspect 34: A non-transitory computer-readable medium storing code for wireless communications at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although the techniques described herein may be described in relation to a 4-step random access procedure, the techniques described herein may be applicable to a 2-step random access procedure. For example, the random access messages described as msg1, msg2, msg3, and msg4 may be described instead as msgA and msgB.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving control information indicating that a network entity supports key derivation associated with a random access procedure with the network entity;
measuring, based at least in part on the control information, one or more reference signals transmitted by the network entity during or prior to the random access procedure to generate a channel estimate of a wireless communication channel between the UE and the network entity; and
communicating, with the network entity during the random access procedure, an indication of one of a match or a mismatch between a first verification bit sequence generated by the UE using a first key derived from the channel estimate and a second verification bit sequence generated by the network entity using a second key derived by the network entity.

2. The method of claim 1, further comprising:
receiving the one or more reference signals in a resource allocated for transmission of a random access response message of the random access procedure.

3. The method of claim 1, further comprising:
communicating one or more messages secured using the first key derived from the channel estimate based at least in part on communicating the indication of a match between the first verification bit sequence and the second verification bit sequence, the one or more messages communicated during the random access procedure, after the random access procedure, or both.

4. The method of claim 1, further comprising:
communicating a message of the random access procedure that has a quasi co-location relationship with the one or more reference signals.

5. The method of claim 1, wherein receiving the control information comprises:
receiving the control information via a master information block, a system information block, a message of the random access procedure, or any combination thereof.

6. The method of claim 1, further comprising:
receiving second control information indicating a metric associated with measuring the channel estimate; and
obtaining the first key using the metric associated with the channel estimate.

7. The method of claim 1, further comprising:
communicating a signal indicating the first verification bit sequence or the second verification bit sequence, wherein communicating the indication of the match or the mismatch is based at least in part on communicating the signal.

8. The method of claim 1, further comprising:
receiving second control information indicating a resource for communicating the indication of one of the match or the mismatch.

9. The method of claim 1, further comprising:
receiving a message of the random access procedure, the message comprising control information indicating the second verification bit sequence.

10. The method of claim 1, further comprising:
communicating the indication of the mismatch between the first verification bit sequence and the second verification bit sequence; and
receiving a message of the random access procedure indicating whether one or more subsequent messages communicated between the UE and the network entity are unsecured based at least in part on the mismatch.

11. The method of claim 1, further comprising:
communicating one or more messages subsequent to the random access procedure that are encrypted using the first key, the one or more messages indicating to update the first key to a third key.

12. The method of claim 1, further comprising:
obtaining the first key using the channel estimate of the wireless communication channel, wherein communicating the indication of one of the match or the mismatch is based at least in part on obtaining the first key.

13. The method of claim 1, further comprising:
receiving the one or more reference signals prior to the random access procedure, wherein measuring the one or more reference signals is based at least in part on receiving the one or more reference signals.

14. The method of claim 1, further comprising:
generating the channel estimate based at least in part on measuring the one or more reference signals, the channel estimate comprising a demodulation reference signal metric, a log likelihood ratio metric, or a combination thereof.

15. A method for wireless communications at a network entity, comprising:
transmitting control information indicating that the network entity supports key derivation associated with a random access procedure with the network entity;
measuring, based at least in part on the control information, one or more reference signals transmitted by a user equipment (UE) during the random access procedure to generate a channel estimate of a wireless communication channel between the UE and the network entity; and
communicating, during the random access procedure, an indication of one of a match or a mismatch between a first verification bit sequence generated by the UE using a first key derived by the UE and a second verification bit sequence using a second key derived from the channel estimate by the network entity.

16. The method of claim 15, further comprising:
transmitting the one or more reference signals in a resource allocated for transmission of a random access response message of the random access procedure.

17. The method of claim 15, further comprising:
communicating one or more messages secured using the second key derived from the channel estimate based at least in part on communicating the indication of a match between the first verification bit sequence and the second verification bit sequence, the one or more messages communicated during the random access procedure, after the random access procedure, or both.

18. The method of claim 15, further comprising:
communicating a message of the random access procedure that has a quasi co-location relationship with the one or more reference signals.

19. The method of claim 15, wherein transmitting the control information comprises:
transmitting the control information via a master information block, a system information block, a message of the random access procedure, or any combination thereof.

20. The method of claim 15, further comprising:
transmitting second control information indicating a metric associated with the generated channel estimate; and
obtaining the second key using the metric associated with the channel estimate.

21. The method of claim 15, further comprising:
communicating a signal indicating the first verification bit sequence or the second verification bit sequence, wherein communicating the indication of the match or the mismatch is based at least in part on communicating the signal.

22. The method of claim 15, further comprising:
transmitting second control information indicating a resource for communicating the indication of one of the match or the mismatch.

23. The method of claim 15, further comprising:
transmitting a message of the random access procedure, the message comprising control information indicating the second verification bit sequence.

24. The method of claim 15, further comprising:
communicating the indication of the mismatch between the first verification bit sequence and the second verification bit sequence; and
transmitting a message of the random access procedure indicating whether one or more subsequent messages communicated between the UE and the network entity are unsecured based at least in part on the mismatch.

25. The method of claim 15, further comprising:
communicating one or more messages subsequent to the random access procedure that are encrypted using the first key, the one or more messages indicating to update the first key to a third key.

26. The method of claim 15, further comprising:
obtaining the second key using the channel estimate of the wireless communication channel, wherein communicating the indication of one of the match or the mismatch is based at least in part on obtaining the second key.

27. The method of claim 15, further comprising:
transmitting the one or more reference signals prior to the random access procedure, wherein measuring the one or more reference signals is based at least in part on transmitting the one or more reference signals.

28. The method of claim 15, further comprising:
generating the channel estimate based at least in part on measuring the one or more reference signals, the channel estimate comprising a demodulation reference signal metric, a log likelihood ratio metric, or a combination thereof.

29. An apparatus for wireless communications at a user equipment (UE), comprising:
a processor;
memory coupled with the processor; and
instructions stored in the memory and executable by the processor to cause the apparatus to:
receive control information indicating that a network entity supports key derivation associated with a random access procedure with the network entity;
measure, based at least in part on the control information, one or more reference signals transmitted by the network entity during or prior to the random access procedure to generate a channel estimate of a wireless communication channel between the UE and the network entity; and
communicate, with the network entity during the random access procedure, an indication of one of a match or a mismatch between a first verification bit sequence generated by the UE using a first key derived from the channel estimate and a second verification bit sequence generated by the network entity using a second key derived by the network entity.

30. An apparatus for wireless communications at a network entity, comprising:
a processor;
memory coupled with the processor; and
instructions stored in the memory and executable by the processor to cause the apparatus to:
transmit control information indicating that the network entity supports key derivation associated with a random access procedure with the network entity;
measure, based at least in part on the control information, one or more reference signals transmitted by a user equipment (UE) during the random access procedure to generate a channel estimate of a wireless communication channel between the UE and the network entity; and
communicate, during the random access procedure, an indication of one of a match or a mismatch between a first verification bit sequence generated by the UE using a first key derived by the UE and a second verification bit sequence using a second key derived from the channel estimate by the network entity.
